(19) United States
(12) Patent Application Publication
(10) Pub. No.: US 2006/0188667 A1
(43) Pub. Date: Aug. 24, 2006

(54) Optical cellulose acylate film and a method of manufacturing the same

(75) Inventors: Saisuke Watanabe, Minami-Ashigara-shi (JP); Zemin Shi, Minami-Ashigara-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/344,196

(22) Filed: Feb. 1, 2006

(30) Foreign Application Priority Data
Feb. 1, 2005 (JP) 025228/2005
May 12, 2005 (JP) 140113/2005

(51) Int. Cl. C09K 19/00

(52) U.S. Cl. 428/1.33

(57) ABSTRACT

An optical cellulose acylate film satisfying (1)-(3) below, and showing a reduction of only 30% or less in both of its number-average and weight-average molecular weights when heated for 20 minutes at a temperature 10° C. higher than its melting point in an inert gas atmosphere: (1): 2.4≦A+B<3.0 (2): 0≦A≦1.5 (3): 0.9<B<3 wherein A represents the substitution degree of acetyl groups in cellulose acylate, and B represents the total substitution degree of acyl groups having 3 to 7 carbon atoms in cellulose acylate.

### BACKGROUND OF THE INVENTION

1. Field of the Invention

This invention relates to an optical cellulose acylate film and a method of manufacturing the same. The optical cellulose acylate film according to this invention is useful as a film for a liquid crystal display device, and is particularly suitable for use as a retardation film.

2. Description of the Related Art

It has been usual practice to stretch a cellulose acylate film to cause it to manifest in-plane retardation (Re) and retardation of a thickness direction (Rth) to use it as a retardation film for a liquid crystal display device and thereby realize a widened viewing angle. A 2- or 3-substituted cellulose acetate film has been mainly used for an STN liquid crystal display device, since it does not require a very high value of Re or Rth. The recent development of a vertical alignment (VA) type liquid crystal display device has, however, come to require a retardation film having higher values of Re and Rth, In order to provide such a retardation Film, there is disclosed to the public an art relying on a film formed by solution casting a cellulose acylate film containing a propionyl group in a substitution degree of 0.6 to 1.2 beside an acetyl group (Publication 1: JP-A-2001-188128).

Various arts have been studied for eliminating the discharge of any organic solvent for the purpose of environment protection, but further studies are required for the complete elimination of any such discharge. Publication 2 (JP-A-2000-352620) proposes a melt extrusion method of forming a cellulose acylate film as a film-forming method not using any organic solvent. This method is described as melting a cellulose ester (cellulose acylate) by heating it to a temperature causing it to show fluidity without the aid of any organic solvent and extruding the molten cellulose ester onto an endless belt or drum to form a film.

The cellulose acylate film shown by Publication 2 as a product of the melt extrusion method, however, exhibits only a low level of retardation. I, the inventor of the present invention, have tried to achieve a high level of retardation on the basis of the disclosure of Publication 2, but have failed to realize any satisfactorily high level of retardation.

### SUMMARY OF THE INVENTION

It is, therefore, an object of the present invention to provide a cellulose acylate optical film capable of manifesting a sufficiently high level of retardation for a retardation film and a method of manufacturing such a film.

I have tried to obtain an improved cellulose acylate film formed by a melt extrusion method, presuming that the starting cellulose acylate may be responsible for the low level of retardation of a film hitherto formed therefrom by a melt extrusion method. As a result of my serious study based on such assumption, I have found that the use of cellulose acylate showing a certain level of thermal characteristics in a melt extrusion method gives a film manifesting a drastically improved level of retardation.

As a result of further studies, I have discovered that a melt extrusion method of forming a film from such a thermally stable cellulose acylate in an inert gas atmosphere is the most effective method of forming a film manifesting a high level of retardation. I have also found as a secondary result that it is possible to form a film not undergoing any yellowing that is usually observed on any product of a melt extrusion method.

Moreover, I have unexpectedly found that the concept of the present invention makes it possible to prevent any molten cellulose acylate from remaining adherent to a film-forming die and form a film free from any die line.

The use of a film having properties as described above in a polarizing plate gives a liquid crystal display device producing a very good image.

The above object of the present invention is attained by the following features thereof:

[1] An optical cellulose acylate film satisfying the requirements of (1) to (3) below, and showing a reduction of only 30% or less in both of its number-average and weight-average molecular weights when heated for 20 minutes at a temperature 10° C. higher than its melting point in an inert gas atmosphere:

(1): 2.4≦A+B<3.0

(2): 0≦A≦1.5

(3): 0.9<B<3

wherein A represents the substitution degree of acetyl groups in cellulose acylate, and B represents the total substitution degree of acyl groups having 3 to 7 carbon atoms in cellulose acylate.

[2] An optical cellulose acylate film as set forth at [1] above, satisfying the requirements of (4) to (6) below:

(4): Re≦Rth

(5): 0 nm≦Re≦300 nm

(6): 0 nm≦Rth≦500 nm

wherein Re represents an in-plane retardation of the film and Rth represents retardation of a thickness direction of the film.

[3] An optical cellulose acylate film as set forth at [1] above, satisfying the requirements of (7) to (9) below:

(7): Re≦Rth

(8): 50 nm≦Re≦100 nm

(9): 150 nm≦Rth≦250 nm

wherein Re represents an in-plane retardation of the film and Rth represents retardation of a thickness direction of the film.

[4] An optical cellulose acylate film as set forth at one of [1] to [3] above, having an breaking elongation of 150 to 300% when stretched at a temperature 10° C. higher than its glass transition point.

The amount of residual solvent in the film is preferably 0.01% by mass or less. The cellulose acylate is preferably cellulose acetate propionate or cellulose acetate butyrate. The thickness of the optical cellulose acylate film is preferably 30 to 400 μm.

[5] A method of manufacturing an optical cellulose acylate film as set forth at one of [1] to [4] above, comprising forming a film by a melt extrusion process from a cellulose acylate composition satisfying the requirements of (1) to (3) below:

(1): 2.4≦A+B<3.0

(2): 0≦A≦1.5

(3): 0.9<B<3

wherein A represents the substitution degree of acetyl groups in cellulose acylate, and B represents the total substitution degree of acyl groups having 3 to 7 carbon atoms in cellulose acylate.

[6] A method as set forth at [5] above, wherein the melt extrusion process is carried out in an inert gas atmosphere.

In the method, the cellulose acylate preferably has a melting point of 170 to 230° C.

[7] A polarizing plate comprising at least one cellulose acylate film as set forth at one of [1] to [4] above.

[8] A retardation film comprising at least one cellulose acylate film as set forth at one of [1] to [4] above.

[9] An optical compensation film comprising at least one cellulose acylate film as set forth at one of [1] to [4] above.

[10] A reflection-preventing film comprising at least one cellulose acylate film as set forth at one of [1] to [ ] above.

[11] An image display device comprising at least one film selected from the group consisting of a cellulose acylate film as set forth at one of [1] to [4] above, a polarizing plate as set forth at [7], a retardation film as set forth at [8], an optical compensation film as set forth at [9] and a reflection-preventing film as set forth at [10].

The present invention makes available a cellulose acylate optical film allowing cellulose acylate to manifest a high level of retardation, while not undergoing any yellowing or having any die line formed thereon. This film makes available a polarizing plate, a retardation film, an optical compensation film or a reflection-preventing film exhibiting an excellent optical performance, or a liquid crystal display device providing an excellent image quality, particularly a VA type liquid crystal display device.

### BEST MODE OF CARRYING OUT THE INVENTION

Description will now be made in detail of the cellulose acylate optical film according to the present invention. Although the following description of its structural features may often be made on the basis of typical embodiments of the present invention, it is to be understood that the present invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted,

(Structure of Cellulose Acylate)

Description will first be made in detail of the cellulose acylate used for the purpose of the present invention (hereinafter referred to simply as the cellulose acylate of the present invention). The cellulose acylate of the present invention is characterized by containing acyl groups having 2 to 7 carbon atoms and having an acyl substitution degree of from 2.4 to less than 3.0.

The glucose units having a β-1, 4 bond and forming the cellulose have free hydroxyl groups in the 2-, 3- and 6-positions thereof. The cellulose acylate is a polymer obtained by esterifying a part or all of those hydroxyl groups. Its acyl substitution degree means the total of the esterification degrees of cellulose in the 2-, 3- and 6-positions (an esterification degree of 100% meaning a substitution degree of 1). According to the present invention, its acyl substitution degree is from 2.4 to less than 3.0, preferably from 2.6 to 2.96 and more preferably from 2.6 to 2.95.

Although the present invention does not specifically limit the substitution degree of hydroxyl groups in the 2-, 3- or 6-position of the cellulose, cellulose acylate having a hydroxyl substitution degree of at least 0.8, preferably at least 0.85 and more preferably at least 0.90 in the 6-position thereof is improved in solubility and makes a good solution particularly in a non-chlorine organic solvent.

The acyl groups in the cellulose acylate of the present invention may be either aliphatic or aromatic. Examples of the preferred acyl groups are acetyl, propionyl, butyryl, pentyl, hexanoyl, heptanoyl, isobutyryl, tert-butyryl, cyclo-hexanecarbonyl and benzoyl groups. The more preferable thereof are acetyl, propionyl and butyryl, and the still more preferable are acetytl and butyryl.

The cellulose acylate of the present invention may also be a mixed ester. Preferred examples are cellulose acetate propionate, cellulose acetate butyrate, cellulose propanoate butyrate, cellulose acetate hexanoate and cellulose acetate cyclohexanoate. The more preferable thereof are cellulose acetate propionate and cellulose acetate butyrate, and the still more preferable is cellulose acetate butyrate.

The cellulose acylate of the present invention satisfies the requirements of (1) to (3) representing the modes of substitution, in which A represents the substitution degree of acetyl groups and B represents the total substitution degree of acyl groups having 3 to 7 carbon atoms:

(1): 2.4≦A+B<3.0

(2): 0≦A≦1.5

(3): 0.9<B<3

preferably,

(1a): 2.5≦A+B<3.0

(2a): 0≦A≦1.5

(3a): 1.0≦B<3

more preferably,

(1b): 2.5≦A+B<3.0

(2b): 0≦A≦1.3

(3b): 1.2≦B<3

still more preferably,

(1c): 2.6≦A+B<3.0

(2c): 0≦A≦1.0

(3c): 1.6≦B<3

A high total substitution degree of acyl groups having 3 to 7 carbon atoms with a low acetyl substitution degree is preferred for restraining any lack of uniformity in the stretching of a cellulose acylate film and thereby any lack of uniformity in in-plane retardation (Re) or retardation of a thickness direction (Rth), while also lowering its melting point (or crystal melting temperature, Tm). It is also effective for restraining any yellowing resulting from decomposition by the heat of melting. Accordingly, it is a structure suited for forming a film by a melt extrusion method.

The average substitution degree of acyl groups can be determined by, for example, a method conforming to ASTM D-817-91, a method comprising hydrolyzing cellulose acylate completely and determining the amount of a liberated carboxylic acid or a salt thereof by gas or high-speed liquid chromatography or a ¹H-NMR or ¹³C-NMR method or a combination of those methods.

<Method of Preparing Cellulose Acylate>

Description will now be made in detail of a method of preparing cellulose acylate of the present invention. Raw cotton and a synthesizing method for the cellulose acylate of the present invention are also described in detail in Published Technical Report of the Hatsumei Kyokai (Association of Inventions) (Published Report No. 2001-1745, published on Mar. 15, 2001 by Hatsumei Kyokai), pages 7 to 12.

(Raw Materials and Preliminary Treatment)

The material for cellulose is preferably derived from hardwood or softwood pulp, or cotton linter. The material for cellulose is preferably one of high purity having an α-cellulose content of 92 to 99.9% by mass.

If the material is in the form of a sheet or block, it is preferably crushed prior to use and its crushing is preferably carried out until cellulose becomes fluffy.

(Activation)

The material for cellulose is preferably treated with an activating agent (or activated) prior to acylation. A carboxylic acid or water can be used as the activating agent and when water is used, activation is preferably followed by the step of adding an excess of an acid anhydride for dehydration, washing with a carboxylic acid to replace water, or adjusting the conditions of acylation. The activating agent may be added at any temperature by such a method as spraying, dropping or dipping.

Carboxylic acids preferred as an activating agent are carboxylic acids having 2 to 7 carbon atoms (for example, acetic acid, propionic acid, butyric acid, 2-methylpropionic acid, valeric acid, 3-methylbutyric acid, 2-methylbutyric acid, 2, 2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3, 3-dimethylbutyric acid, cyclopentanecarboxylic acid, heptanoic acid, cyclohexanecarboxylic acid and benzoic acid), more preferably acetic, propionic or butyric acid, and still more preferably acetic acid.

An acylation catalyst, such as sulfuric acid, may be added at the time of activation, if required. However, as the addition of a strong acid, such as sulfuric acid, can promote depolymerization, its addition is preferably limited to, say, 0.1 to 10% by mass of cellulose. It is also possible to use two or more kinds of activating agents together, or add an acid anhydride of carboxylic acid having 2 to 7 carbon atoms.

The amount of the activating agent to be added is preferably at least 5%, more preferably at least 10% and still more preferably at least 30%, by mass of cellulose. The amount of the activating agent which is equal to or larger than the lower limit stated above is preferable for avoiding any inconvenience, such as a reduction in the activation degree of cellulose. The upper limit of the amount of the activating agent is not specifically set except for avoiding a lowering of productivity, but is preferably at most 100 times, more preferably at most 20 times and still more preferably at most 10 times, by mass as large as cellulose. It is allowable to carry out activation by adding a large excess of activating agent over cellulose and then reduce its amount by operations, such as filtration, air drying, drying under heat, vacuum distillation and solvent substitution.

Time for activation is preferably 20 minutes or more and while its upper limit is not specifically set unless it affects productivity, it is preferably 72 hours or less, more preferably 24 hours or less and still more preferably 12 hours or less. The activation temperature is preferably from 0° C. to 90° C., more preferably from 15° C. to 80° C. and still more preferably from 20° C. to 60° C. The activation of cellulose may also be carried out at an elevated or reduced pressure. Electromagnetic waves, such as microwaves or infrared radiation, may be used as a source of heat.

(Acylation)

In a method of preparing cellulose acylate according to the present invention, it is preferable to add a carboxylic acid anhydride to cellulose and react them in the presence of a Brönsted or Lewis acid as a catalyst to acylate the hydroxyl groups of cellulose. The synthesis of cellulose acylate having a high degree of substitution at the 6-position is described in, for example, JP-A-H11-5851, JP-A-2002-212338 and JP-A-2002-338601.

Other methods that can be used to synthesize cellulose acylate are a method in which a carboxylic acid anhydride and a carboxylic acid halide are reacted with each other in the presence of a base (such as sodium hydroxide, potassium hydroxide, barium hydroxide, sodium carbonate, pyridine, triethylamine, tert-butoxypotassium, sodium methoxide or sodium ethoxide) and a method employing a mixed acid anhydride (such as a mixed carboxylic and trifluoroacetic acid anhydride or a mixed carboxylic and methanesulfonic acid anhydride) as an acylating agent, and the latter method is particularly effective for introducing an acyl group having a large number of carbon atoms or an acyl group which is difficult to introduce by an acylating method relying on a carboxylic acid anhydride, acetic acid and a sulfuric acid catalyst.

Cellulose mixed acylate can be obtained by using, for example, a method in which two kinds of carboxylic acid anhydrides are added in a mixed state or one after the other as an acylating agent to be reacted with cellulose, a method employing a mixed acid anhydride of two kinds of carboxylic acids (for example, a mixed acetic and propionic acid anhydride) a method in which a mixed acid anhydride (for example, a mixed acetic and propionic acid anhydride) is synthesized in a reaction system from a carboxylic acid and the anhydride of another carboxylic acid (for example, acetic acid and propionic acid anhydride) and reacted with cellulose, or a method in which cellulose acylate having a substitution degree of less than 3 is synthesized and has its remaining hydroxyl groups acylated by using an acid anhydride or halide.

(Acid Anhydrides)

Preferred examples of carboxylic acid anhydrides are of carboxylic acids having 2 to 7 carbon atoms and include anhydrous acetic acid, propionic acid anhydride, butyric acid anhydride, 2-methylpropionic acid anhydride, valeric acid anhydride, 3-methylbutyric acid anhydride, 2-methylbutyric acid anhydride, 2,2-dimethylpropionic acid anhydride (pivalic acid anhydride), hexanoic acid anhydride, 2-methylvaleric acid anhydride, 3-methylvaleric acid anhydride, 4-methyl-valeric acid anhydride, 2,2-dimethylbutyric acid anhydride, 2, 3-dimethylbutyric acid anhydride, 3,3-dimethylbutyric acid anhydride, cyclopentanecrboxylic acid anhydride, heptanoic acid anhydride, cyclohexanecarboxylic acid anhydride and benzoic acid anhydride.

More preferable are anhydrous acetic acid, propionic acid anhydride, butyric acid anhydride, valeric acid anhydride, hexanoic acid anhydride, heptanoic acid anhydride, etc. and still more preferable are anhydrous acetic acid, propionic acid anhydride and butyric acid anhydride.

The use of a combination of these acid anhydrides is preferably made for preparing a mixed ester. Their mixing ratio is preferably selected in accordance with the substitution ratio of a mixed ester as intended. The acid anhydride is usually added in an excess equivalent to cellulose. More specifically, it is preferable to add from 1.2 to 50, more preferably from 1.5 to 30 and still more preferably from 2 to 10 equivalents to the hydroxyl groups of cellulose.

(Catalyst)

A Brönsted or Lewis acid is preferably used as an acylation catalyst in preparing cellulose acylate according to the present invention. The definitions of the Brönsted and Lewis acids are found in, for example, “Rikagaku Jiten” (Encyclopedia of Physics and Chemistry), 5th Edition (2000). Preferred examples of Brönsted acids are sulfuric acid, perchloric acid, phosphoric acid, methanesulfonic acid, benzenesulfonic acid and p-toluenesulfonic acid. Preferred examples of Lewis acids are zinc chloride, tin chloride, antimony chloride and magnesium chloride.

Sulfuric or perchloric acid is more preferable as a catalyst and sulfuric acid is still more preferable. The catalyst is preferably added in the amount of from 0.1 to 30%, more preferably from 1 to 15% and still more preferably from 3 to 12% by mass of cellulose.

(Solvent)

A solvent may be added at the time of acylation for adjusting viscosity, reaction rate, stirring property, acyl substitution ratio, etc. While dichloromethane, chloroform, carboxylic acid, acetone, ethyl methyl ketone, toluene, dimethyl sulfoxide or sulfolane can, for example, be used as the solvent, carboxylic acid is preferred, including, for example, carboxylic acid having 2 to 7 carbon atoms {for example, acetic acid, propionic acid, butyric acid, 2-methylpropionic acid, valeric acid, 3-methylbutyric acid, 2-methylbutyric acid, 2,3-dimethylpropionic acid (pivalic acid), hexanoic acid, 2-methylvaleric acid, 3-methylvaleric acid, 4-methyl-valeric acid, 2,2-dimethylbutyric acid, 2,3-dimethylbutyric acid, 3, 3-dimethylbutyric acid or cyclopentanecarboxylic acid}. Acetic acid, propionic acid, butyric acid, etc. are, among others, preferred. A mixture of solvents can also be used.

(Conditions for Acylation)

Although acylation can be carried out by mixing a mixture of an acid anhydride, a catalyst and a solvent, if required, with cellulose, or by mixing them one after another with cellulose, it is usually preferable to prepare a mixture of an acid anhydride and a catalyst, or a mixture of an acid anhydride, a catalyst and a solvent as an acylating agent and react it with cellulose. It is preferable to cool the acylating agent beforehand to restrain any temperature elevation in the reaction vessel by the heat of the acylation reaction. It is preferably cooled to a temperature of from −50° C. to 20° C., more preferably from −35° C. to 10° C., and still more preferably from −25° C. to 5° C. The acylating agent may be employed in a liquid state, or may be frozen and employed in a solid state in crystal, flake or block form.

The acylating agent may be added to cellulose all at a time, or may be added thereto a plurality of times. Alternatively, cellulose may be added to the acylating agent all at a time, or may be added thereto a plurality of times. When the acylating agent is added a plurality of times, it is possible to use a single kind of acylating agent or a plurality of acylating agents differing from one another in composition. Preferred cases include (1) adding first a mixture of an acid anhydride and a solvent, and then a catalyst, (2) adding first a mixture of an acid anhydride, a solvent and a part of a catalyst, and then a mixture of the remaining catalyst and the solvent, (3) adding first a mixture of an acid anhydride and a solvent, and then a mixture of a catalyst and the solvent, and (4) adding first a solvent, and then a mixture of an acid anhydride and a catalyst, or a mixture of the acid anhydride, catalyst and solvent.

Although the acylation of cellulose is an exothermic reaction, it is preferable that a maximum temperature of 50° C. not be exceeded by acylation in the method of preparing cellulose acylate according to the present invention. The reaction temperature not exceeding that level is preferable for avoiding any inconvenience such as the progress of depolymerization making it difficult to obtain cellulose acylate having a polymerization degree suited for the purpose of the present invention. The maximum temperature not to be exceeded by acylation is preferably 45° C., more preferably 40° C. and still more preferably 35° C. The reaction temperature may be controlled by using a temperature controller, or by controlling the initial temperature of the acylating agent. It is also possible to evacuate the reaction vessel and control the reaction temperature by the heat generated by the evaporation of the liquid component in the reaction system. It is also effective to employ cooling during the initial period of the reaction and heating thereafter, since the generation of heat by acylation is remarkable during the initial period of the reaction. The end point of acylation can be determined by means of light transmittance, solution viscosity, temperature change in the reaction system, solubility of the reaction product in an organic solvent, observation through a polarizing microscope, etc.

The minimum temperature of the reaction is preferably −50° C., more preferably −30° C. and still more preferably −20° C., Time for acylation is preferably from 0.5 to 24 hours, more preferably from 1 to 12 hours and still more preferably from 1.5 to 6 hours. If it is less than 0.5 hour, the reaction does not proceed satisfactorily under the usual reaction conditions, while no time exceeding 24 hours is desirable for industrial production.

(Reaction Terminator)

According to the method of preparing cellulose acylate for the purpose of the present invention, the acylation reaction is preferably followed by the addition of a reaction terminator.

The reaction terminator may be anything that can decompose an acid anhydride, and preferred examples are water, alcohol (such as ethanol, methanol, propanol or isopropyl alcohol) or a composition containing them. The reaction terminator may also contain a neutralizing agent, as will be stated below. When the neutralizing agent is added, the addition of a mixture of a carboxylic acid, such as acetic, propionic or butyric acid, and water is preferable to the direct addition of water or alcohol for avoiding the generation of a large amount of heat exceeding the cooling capacity of the reaction apparatus and causing inconveniences, such as a reduction in the polymerization degree of cellulose acylate and any undesired sedimentation of cellulose acylate. Acetic acid is preferable to any other carboxylic acid. While any ratio of carboxylic acid and water can be employed, the proportion of water is preferably from 5 to 80%, more preferably from 10 to 60% and still more preferably from 15 to 50% by mass.

The reaction terminator may be added to the reaction vessel for acylation, or alternatively, the reaction mixture may be added to a container for the reaction terminator. The addition of the reaction terminator preferably takes from three minutes to three hours. Its addition taking three minutes or more is preferable for avoiding any inconvenience, such as the generation of so large an amount of heat as to cause a lowering in the polymerization degree of cellulose acylate, insufficient hydrolysis of the acid anhydride or a lowering in stability of cellulose acylate. Its addition not taking more than three hours is preferable for avoiding any problem, such as a reduction in industrial productivity. Its addition more preferably takes from four minutes to two hours, still more preferably from five minutes to one hour and still more preferably from 10 to 45 minutes. While the addition of the reaction terminator does not essentially require any cooling of the reaction vessel, its cooling is preferable for restraining any undesirable temperature elevation and thereby any depolymerization. The reaction terminator is preferably cooled, too.

(Neutralizing Agent)

A neutralizing agent (for example, the carbonate, acetate, hydroxide or oxide of calcium, magnesium, iron, aluminum or zinc) or a solution thereof may be added during the step of terminating the acylation reaction or thereafter to hydrolyze any excessive carboxylic acid anhydride remaining in the system and neutralize a part or all of the carboxylic acid and esterifying catalyst. Preferred examples of solvents for the neutralizing agent are water, alcohols (for example, ethanol, methanol, propanol and isopropyl alcohol), carboxylic acids (for example, acetic acid, propionic acid and butyric acid), ketones (for example, acetone and ethyl methyl ketone), dimethylsulfoxide and other polay solvents, and a mixture thereof.

(Partial Hydrolysis)

As the cellulose acylate obtained as described has a total substitution degree of nearly 3, it is usual practice to hold it at a temperature of 20° C. to 90° C. for several minutes to several days in the presence of a small amount of catalyst (usually an acylation catalyst, such as the remaining sulfuric acid) and water for hydrolyzing the ester bonds partially and lowering the acyl substitution degree of cellulose acylate to a desired level (or aging it). As the process of the partial hydrolysis causes the hydrolysis of the sulfuric acid ester of cellulose, too, it is possible to reduce the amount of the sulfuric acid ester bonded to cellulose by controlling the conditions of the hydrolysis.

(Termination of Partial Hydrolysis)

When the desired cellulose acylate has been obtained, it is preferable to neutralize the catalyst remaining in the system completely by using a neutralizing agent as mentioned above or a solution thereof to terminate the partial hydrolysis. The addition of a neutralizing agent (for example, magnesium carbonate or acetate) forming a salt having low solubility in the reacted solution is desirable for the effective removal of the catalyst (for example, sulfuric acid ester) in the solution or bonded to cellulose.

(Heating After Neutralization)

Sufficient heating in the presence of water after the addition of the neutralizing agent makes it possible to remove the remaining sulfuric acid ester and improve the thermal stability of cellulose acylate. Its substitution and polymerization degrees can be maintained, since the acid used as the catalyst has already disappeared. It is preferably heated to a temperature of from 40° C. to 150° C., more preferably from 40° C. to 120° C. and still more preferably from 40° C. to 100°. It is preferably heated for 1 to 24 hours, more preferably for 1 to 12 hours and still more preferably for one to six hours.

(Filtration)

The reaction mixture (dope) is preferably subjected to filtration for removing or reducing any unreacted matter, sparingly soluble salt and any other foreign matter from the cellulose acylate. Its filtration may be carried out at any stage from the completion of acylation to reprecipitation. Its dilution with a suitable solvent prior to its filtration is preferable for controlling its filtration pressure and its ease of handling.

(Reprecipitation)

The cellulose acylate solution as obtained is mixed in a poor solvent such as water or an aqueous solution of a carboxylic acid (e.g. acetic or propionic acid), or a poor solvent is mixed in the cellulose acylate solution, so that cellulose acylate may be reprecipitated, and its washing and stabilization treatment give the intended cellulose acylate. Its reprecipitation may be carried out continuously, or on a batch basis. It is preferable to adjust the concentration of the cellulose acylate solution and the composition of the poor solvent by the mode of substitution of cellulose acylate or its polymerization degree to thereby control the form of the reprecipitated cellulose acylate and its molecular weight distribution.

In order to e.g. achieve an improved refining result and a controlled molecular weight distribution or apparent density, it is effective to dissolve the reprecipitated cellulose acylate again in its good solvent (for example, acetic acid or acetone) and react its solution with a poor solvent (for example, water) for reprecipitation, which operation may be repeated a plurality of times as required.

(Washing)

The cellulose acylate as produced is preferably washed. Any washing solvent may be used if it sparingly dissolves cellulose acylate and yet can remove impurities therefrom, though water or warm water is usually employed. Washing water preferably has a temperature of from 25° C. to 100° C., more preferably from 30° C. to 90° C. and still more preferably from 40° C. to 80° C. Washing treatment may be made on a batch basis by repeating filtration and the change of the washing solution, or by using a continuous washing apparatus. The waste solution resulting from the steps of reprecipitation and washing is preferably reused as a poor solvent for another step of reprecipitation, or distilled or otherwise treated so that a solvent, such as carboxylic acid, may be recovered for reuse.

While any method can be used for checking the progress of washing, preferred examples thereof rely on hydrogen ion concentration, ion chromatography, electrical conductivity, ICP, elemental analysis and atomic absorption spectrum.

Such treatment makes it possible to remove the catalyst (such as sulfuric acid, perchloric acid, trifluoroacetic acid, p-toluenesulfonic acid, methanesulfonic acid or zinc chloride), the neutralizing agent (such as the carbonate, acetate, hydroxide or oxide of calcium, magnesium, iron, aluminum or zinc), the reaction product of the neutralizing agent and the catalyst, the carboxylic acid (such as acetic, propionic or butyric acid), the reaction product of the neutralizing agent and the carboxylic acid, etc. from cellulose acylate, and is, therefore, effective for increasing the stability of cellulose acylate.

(Stabilization)

The cellulose acylate which has been washed by warm water treatment is preferably treated with e.g. an aqueous solution of a weak alkali (for example, the carbonate, hydrogen carbonate, hydroxide or oxide of sodium, potassium, calcium, magnesium or aluminum) in order to be further improved in stability, or have any odor of carboxylic acid removed.

The amount of the remaining impurities can be controlled by the amount of the washing solution, washing temperature or time, a method of stirring, the shape of a washing container the composition and concentration of the stabilizing agent.

(Drying)

Cellulose acylate is preferably dried to have its water content adjusted to a desired level in accordance with the present invention. While any drying method can be employed if it enables the intended water content to be realized, it is desirable to perform drying efficiently by employing a method such as heating, air blowing, pressure reduction or stirring, or a combination thereof. Drying is preferably performed at a temperature of from 0° C. to 200° C., more preferably from 40° C. to 180° C. and still more preferably from 50° C. to 160° C. The cellulose acylate of the present invention preferably has a water content of 2% by mass or less, more preferably 1% by mass or less, and still more preferably 0.7% by mass or less.

(Form)

The cellulose acylate of the present invention may have any of various forms, such as particulate, powdery, fibrous or block, but since it is preferably particulate or powdery as a material for film manufacture, the cellulose acylate as dried may be crushed or sieved to have a uniform particle size and an improved property of handling. When cellulose acylate is particulate, at least 90% by mass of its particles which are used preferably have a particle size of 0.5 to 5 mm. Moreover, at least 50% by mass of its particles which are used preferably have a particle size of 1 to 4 mm. The cellulose acylate particles are preferably as close to spherical as possible in shape.

(Polymerization Degree)

Referring to the polymerization degree of cellulose acylate preferred for use by the present invention, its number-average polymerization degree (i.e. its number-average molecular weight divided by the molecular weight of the glucose unit in cellulose acylate) is from 100 to 400, preferably from 100 to 300, more preferably from 120 to 220 and still more preferably from 130 to 220. Its average polymerization degree can be determined by e.g. the limiting viscosity method of Uda et al (Kazuo Uda and Hideo Saito: Journal of the Society of Fibers, Vol. 18, No. 1, pages 105 to 120, 1962), or a method of determining a molecular weight distribution by gel permeation chromatography (GPC). For further details, reference is made to JP-A-H9-95538.

According to the present invention, the weight-average polymerization degree/number-average polymerization degree of cellulose acylate as determined by GPC is preferably from 2.0 to 5.0, more preferably from 2.2 to 4.5 and still more preferably from 2.4 to 4.0.

(Minute Foreign Matter in Cellulose Acylate)

Minute foreign matter in cellulose acylate comes from unreacted cellulose fibers. Any minute foreign matter remaining in an optical film appears as a bright point when the film is sandwiched between two polarizing plates arranged in crossed nicols. The bright point can cause the leakage of light in a liquid crystal display device. Accordingly, it is preferable to reduce any minute foreign matter in cellulose acylate as far as possible. More specifically, the number of particles of minute foreign matter is estimated as stated below.

A sample weighing about 10 mg is held between two glass slides each measuring 1 cm square by 150 μm thick and melted to form a transparent film of cellulose acylate having a thickness of about 50 μm between the glass slides. The thickness of the cellulose acylate film can be calculated by deducting the original thickness of the glass slides from the thickness of the two glass slides having the cellulose acylate film held therebetween. If its thickness differs greatly from 50 μm, conversion can be made later. The cellulose acylate film as prepared between the glass slides has its given area of 1 mm examined through a microscope so that the number of particles of minute foreign matter per 1 mm²×50 μm=5×10⁻² mm³ may be counted. The number of particles of minute foreign matter which are found as having a length of 10 μm or less is 10 or less, preferably 5 or less, more preferably 2 or less and still more preferably 0 per 5×10⁻² mm³. Although it is likely that particles of minute foreign matter having a length over 10 μm may also be contained, only particles having a length of 10 μm or less are checked according to the present invention, since the number of the former particles is substantially proportional to that of the latter.

(Residual Sulfur in Cellulose Acylate)

When sulfuric acid is used as the catalyst in the above method of preparing cellulose acylate, it is likely that a sulfuric acid ester may remain in the cellulose acylate as finally obtained. It is likely to affect the thermal stability of cellulose acylate. Accordingly, it is desirable for the sulfuric acid ester to be limited to a small amount. More specifically, its amount in cellulose acylate is preferably 100 ppm or less, more preferably 70 ppm or less, still more preferably 30 ppm or less and most preferably 10 ppm or less on a sulfur atom basis.

(Thermal Characteristics of Cellulose Acylate)

The cellulose acylate of the present invention is required to have a practically acceptable melting point, since it is used for forming a film by a melt extrusion method. If its melting point is too high, its decomposition takes place before melting. If its melting point is too low, it fails to make a practically useful optical film. Accordingly, its melting point is preferably from 170° to 230° C., more preferably from 180° C. to 230° C. and still more preferably from 180° C. to 220° C.

It is also required not to undergo any deterioration under heat within a given period of time when it is melted. More specifically, the molten cellulose acylate is required not to undergo any deterioration before it is extruded to a die and forms a film. This can be checked by the following test. When cellulose acylate is melted for 20 minutes at a temperature 10° C. higher than its melting point in an inert gas atmosphere in which it is not substantially affected by oxygen or water, or more simply in a vacuum having a pressure of 10 mm Hg or less, its polymerization degree is preferably lowered only by 30% or less, more preferably by 25% or less and still more preferably by 20% or less.

In order to obtain such thermal stability, it is necessary to reduce any residual sulfur in cellulose acylate, as stated above. The addition of various kinds of additives to cellulose acylate as will be mentioned below is also effective for improving its stability.

<Film Forming>

Although solution casting and melt extrusion can be employed in a method of manufacturing a cellulose acylate optical film according to the present invention, melt extrusion is preferably employed because of the excellent thermal characteristics of cellulose acylate.

The formation of a film by melt extrusion will now be described.

(Pelletization)

When forming a film by melt extrusion, it is preferable to use cellulose acylate in the form of pellets rather than a powder. The following is a method of preparing pellets.

Cellulose acylate is first subjected to full preliminary drying (for 0.1 to 24 hours at a temperature of 80° C. to 150° C.). Then, pellets are prepared by using a twin-screw kneading extruder at a temperature of from 150° C. to 220° C., preferably from 160° C. to 210° C. and more preferably from 170° C. to 200° C., a screw rotating speed of from 100 to 800 rpm, preferably from 150 to 600 rpm and more preferably from 200 to 400 rpm with a dwell time of from five seconds to three minutes, preferably from 10 seconds to two minutes and more preferably from 20 to 90 seconds. The preparation of pellets is preferably carried out in an inert gas atmosphere to restrain any deterioration. The inert gas is preferably nitrogen. Nitrogen preferably has a purity of 95% or higher, more preferably 99% or higher and most preferably 99.5% or higher.

A vent is preferably formed at the outlet of the twin-screw kneading extruder for evacuating it during the preparation of pellets. As a mixed cellulose acylate powder is hydrophilic, it contains about 0.2% by mass of residual water and water promotes the decomposition of a material having a low acetylation degree and is likely to form a crosslinking foreign substance. The vent preferably has a vacuum degree of from 0.9 to 0.001 atmosphere, more preferably from 0.8 to 0.01 atmosphere and still more preferably from 0.7 to 0.1 atmosphere. The evacuation of the twin-screw kneading extruder can be achieved by forming an exhaust port in its screw casing and connecting a vacuum pump to it. The molten material is solidified into strands in warm water having a temperature of from 30° C. to 90° C., preferably from 35° C. to 80° C. and more preferably from 37° C. to 60° C., whereafter they are cut and dried.

According to usual practice, the material melted in the twin-screw kneading extruder is extruded into cold water having a temperature of 5° C. to 20° C. through a die having a large number of holes with a diameter of several millimeters and is solidified into strands, and while they are conveyed, they are dewatered and cut into pellets, The solidifying water temperature is usually as low as stated above. This makes it possible to raise the elastic modulus of the strands and thereby facilitate their transportation. On the other hand, the present invention is characterized by using warm water for solidification, as stated above. As a material having a low acylation degree contains a large number of hydroxyl groups and is easily soluble in water, a solidifying bath having an elevated temperature promotes its dissolution. Time for immersion in warm water is preferably from three seconds to 10 minutes, more preferably from five seconds to five minutes and still more preferably from 10 second to three minutes. It is preferable to pass the strands through cold water having a temperature of 5° C. to less than 30° C. after the above solidifying bath to raise their elastic modulus and facilitate their transportation.

[Plasticizer]

The addition of a plasticizer to the cellulose acylate of the present invention makes it possible to lower its crystal melting temperature (Tm). The plasticizer to be used in accordance with the present invention is not specifically limited in molecular weight, but may have a low or high molecular weight. There are various kinds of plasticizers including phosphoric acid esters, alkylphthalylalkyl glycolates, carboxylic acid esters and fatty acid esters of polyhydric alcohols. The plasticizer may be a solid or an oily substance. Therefore, it is not specifically limited in melting or boiling point. A nonvolatile plasticizer is preferably employed when a film is formed by melt extrusion.

Specific examples of phosphoric acid esters are triphenyl phosphate, tributyl phosphate, tributoxyethyl phosphate, tricresyl phosphate, trioctyl phosphate, trinaphthyl phosphate, trixylyl phosphate, trisorthobiphenyl phosphate, cresylphenyl phosphate, octyldiphenyl phosphate, biphenyldiphenyl phosphate and 1,4-phenylene-tetraphenyl phosphate. It is also preferable to use the phosphate plasticizers as set forth in claims 3 to 7 in JP-T-6-501040.

Examples of alkylphthalylalkyl glycolates are methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate and octyl phthalyl ethyl glycolate.

Examples of carboxylic acid esters are phthalic acid esters such as dimethyl phthalate, diethyl phthalate, dibutyl phthalate, dioctyl phthalate and diethylhexyl phthalate, citric acid esters such as acetyltrimethyl citrate, acetyltriethyl citrate and acetyltributyl citrate, adipic acid esters such as dimethyl adipate, dibutyl adipate, diisobutyl adipate, bis(2-ethylhexyl) adipate, diisodecyl adipate and bis(butyldiglycol adipate), aromatic polycarboxylic acid esters such as tetraoctyl pyromellitate and trioctyl trimellitate, aliphatic polycarboxylic acid esters such as dibutyl adipate, dioctyl adipate, dibutyl sebacate, dioctyl sebacare, diethyl azelate, dibutyl azelate and dioctyl azelate, and fatty acid esters of polyhydric alcohols such as glycerol triacetate, diglycerol tetraacetate, acetylated glyceride, monoglyceride and diglyceride. It is also preferable to use e.g. butyl oleate, methylacetyl ricinolate, dibutyl sebacate or triacetine, or a combination thereof.

There are also high-molecular plasticizers including aliphatic polyesters formed from glycol and dibasic acids, such as polyethylene adipate, polybutylene adipate, polyethylene succinate and polybutylene succinate, aliphatic polyesters formed from oxycarboxylic acids, such as polylactic acid and polyglycolic acid, aliphatic polyesters formed from lactones, such as polycaprolactone, polypropiolactone and polyvalerolactone, vinyl polymers such as polyvinyl pyrrolidone. These plasticizers may each be used alone, or together with a low-molecular plasticizer.

Polyhydric alcohol plasticizers include glycerol ester compounds such as glycerol or diglycerol esters, polyalkylene glycols such as polyethylene or polypropylene glycol, and compounds having acyl groups bonded to hydroxyl groups of polyalkylene glycols, which are highly compatible with cellulose fatty acid esters and produce a remarkable thermoplastic effect.

Specific examples of glycerol esters are glycerol diacetate stearate, glycerol diacetate palmitate, glycerol diacetate myristate, glycerol diacetate laurate, glycerol diacetate caprate, glycerol diacetate nonanate, glycerol diacetate octanoate, glycerol diacetate heptanoate, glycerol diacetate hexanoate, glycerol diacetate pentanoate, glycerol diacetate oleate, glycerol acetate dicaprate, glycerol acetate dinonanate, glycerol acetate dioctanoate, glycerol acetate diheptanoate, glycerol acetate dicaproate, glycerol acetate divalerate, glycerol acetate dibutyrate, glycerol dipropionate caprate, glycerol dipropionate laurate, glycerol diproionate myristate, glycerol dipropionate palmitate, glycerol dipropionate stearate, glycerol dipropionate oleate, glycerol tributyrate, glyceol tripentanoate, glycerol monopalmitate, glycerol monostearate, glycerol distearate, glycerol propionate laurate and glycerol oleate propionate. These esters are merely examples and may be used alone or in combination,

Glycerol diacetate caprilate, glycerol diacetate pelargonate, glycerol diacetate caprate, glycerol diacetate laurate, glycerol diacetate myristate, glycerol diacetate palmitate, glycerol diacetate stearate and glycerol diacetate oleate are, among others, preferred.

Specific examples of diglycerol esters are diglycerol tetraacetate, diglycerol tetrapropionate, diglycerol tetrabutyrate, diglycerol tetravalerate, diglycerol tetrahexanoate, diglycerol tetraheptanoate, diglycerol tetracaprilate, diglycerol tetrapelargonate, diglycerol tetracaprate, diglycerol tetralaurate, diglycerol tetramyristate, diglycerol tetrapalmitate, diglycerol triacetate propionate, diglycerol triacetate butyrate, diglycerol triacetate valerate, diglycerol triacetate hexanoate, diglycerol triacetate heptanoate, diglycerol triacetate caprilate, diglycerol triacetate pelargonate, diglycerol triacetate caprate, diglycerol triacetate laurate, diglycerol triacetate myristate, diglycerol triacetate palmitate, diglycerol triacetate stearate, diglycerol triacetate oleate, diglycerol diacetate dipropionate, diglycerol diacetate dibutyrate, diglycerol diacetate divalerate, diglycerol diacetate dihexanoate, diglycerol diacetate diheptanoate, diglycerol diacetate dicaprilate, diglycerol diacetate pelargonate, diglycerol diacetate dicaprate, diglycerol diacetate dilaurate, diglycerol diacetate dimyristate, diglycerol diacetate dipalmitate, diglycerol diacetate distearate, diglycerol diacetate dioleate, diglycerol acetate tripropionate, diglycerol acetate tributyrate, diglycerol acetate trivalerate, diglycerol acetate trihexanoate, diglycerol acetate triheptanoate, diglycerol acetate tricaprilate, diglycerol acetate tripelargonate, diglycerol acetate tricaprate, diglycerol acetate trilaurate, diglycerol acetate trimyristate, diglycerol acetate tripalmitate, diglycerol acetate tristearate, diglycerol acetate trioleate, diglycerol laurate, diglycerol stearate, diglycerol caprilate, diglycerol myristate, diglycerol oleate and other mixed acid esters of diglycerol. These esters are merely examples and may be used alone or in combination.

Diglycerol tetraacetate, diglycerol tetrapropionate, digkycerol tetrabutyrate, diglycerol tetracaprilate and diglycerol tetralaurate are, among others, preferred. Specific examples of polyalkylene glycols are polyethylene glycol and polypropylene glycol having an average molecular weight of 200 to 1000. These are merely examples and may be used alone or in combination.

Specific examples of compounds having acyl groups bonded to hydroxyl groups of polyalkylene glycols are polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristate, polyoxypropylene palmitate, polyoxypropylene stearate, polyoxypropylene oleate and polyoxypropylene linoleate. These compounds are merely examples and may be used alone or in combination.

The amount of the plasticizer in a cellulose acylate film is preferably from 0 to 20%, more preferably from 1 to 20%, and still more preferably from 2 to 15%, all on a mass basis. Two or more kinds of plasticizers can be used together, if required.

Besides the plasticizer, it is also possible to employ various kinds of additives including a stabilizer, an ultraviolet absorber, a retardation improver, an optical anisotropy controller, minute particles, an infrared absorber, a surface active agent, an odor trapping agent (e.g. amine), as will be described below.

[Stabilizer]

According to the present invention, it is possible to add any of e.g. phosphite compounds, phosphorous ester compounds, phosphates, thiophosphates, weak organic acids or epoxy compounds or a mixture of two or more of them as a stabilizer for preventing deterioration by heat and coloring, if required, to the extent not impairing any performance as desired specific examples of preferred phosphate type stabilizers are the compounds appearing in paragraphs [00233 to [0039] of JP-A-2004-182979. Specific examples of preferred phosphorous ester type stabilizers are the compounds appearing in JP-A-S51-70316, JP-A-H10-306175, JP-A-S57-78431, JP-A-S54-157159 and JP-A-S55-13765.

The amount of the stabilizer in cellulose acylate is preferably from 0.005 to 0.5%, more preferably from 0.01 to 0.4% and more preferably from 0.05 to 0.3%, all on a mass basis. Any amount below 0.005% by mass is undesirable as failing to produce a satisfactory result in preventing the deterioration and coloring of a film formed by melt extrusion. Any amount above 0.5% by mass is also undesirable as the stabilizer comes out on the surface of a cellulose acylate film formed by melt extrusion.

It is also desirable to add a deterioration inhibitor or an oxidation inhibitor. The addition of e.g. a phenolic compound, a thio ether compound or a phosphorus compound as a deterioration or oxidation inhibitor produces a synergistic result in preventing deterioration and oxidation. Other preferred stabilizers are the materials detailed in Published Technical Report of The Hatsumei Kyokai (Association of Inventions) (Report No. 2001-1745, published on Mar. 15, 2001 by Hatsumei Kyokai), pages 17 to 22.

[Ultraviolet Absorber]

The cellulose acylate of the present invention may contain one or more kinds of ultraviolet absorbers. An ultraviolet absorber for a liquid crystal is preferably of the type having a high power of absorbing ultraviolet radiation with a wavelength of 380 nm or less for preventing the deterioration of the liquid crystal and absorbing little visible light with a wavelength of 400 nm or more for ensuring a good liquid crystal display. Examples are an oxybenzophenone compound, a benzotriazole compound, a salicylic acid ester, a benzophenone compound, a cyanoacrylate compound and a complex nickel salt. A benzotriazole or benzophenone compound is, among others, preferred as an ultraviolet absorber. A benzotriazole compound is particularly preferable as it hardly gives any undesired color to cellulose acylate.

Specific examples of preferred ultraviolet absorbers are 2,6-di-tert-butyl-p-cresol, pentaerythrityl-tetrakis{3-(3, 5-di-tert-butyl-4-hydroxuphenyl)propionate}, triethylene glycol-bis-{3-(3-tert-butyl-5-methyl-4-hydroxyphenyl)propionate}, 1,6-hexanediol-bis{3-(3,5-di-tert-butyl-4-hydroxyphenyl)propionate), 2,4-bis-(n-octylthio)-6-(4-hydroxyl-3,5-di-tert-butylanilino)-1,3,5-triazine, 2,2-thio-diethylenebis{3-(3,5-di-tert-butyl-4-hydroxyphenyl)propionate}, octadecyl-3-(3,5-di-tert-butyl-4-hydroxyphenyl)-propionate, N,N9-hexamethylenebis(3,5-di-tert-butyl-4-hydroxy-hydrocinnamide), 1, 3, 5-trimethyl-2, 4, 6-tris(3,5-di-tert-butyl-4-hydroxybenzyl)benzene and tris-(3, 5-di-tert-butyl-4-hydroxybenzyl)isocyanurate.

Other preferred examples are 2,6-di-tert-butyl-p-cresol, pentaerythrityl-tetrakis(3-(3,5-di-tert-butyl-4-hydroxyphenyl)propionate} and triethylene glycol-bis{3-(3-tert-butyl-5-methyl-4-hydroxyphenyl)propionate}. It is also possible to use together a hydrazine type metal deactivator such as N,N9-bis{3-(3,5-di-tert-butyl-4-hydroxyphenyl)propionyl}hydrazine and a phosphorus-based processing stabilizer such as tris(2,4-di-tert-butylphenyl)phosphate. The amount of any such compound in cellulose acylate is preferably from 1 ppm to 3.0% and more preferably from 10 ppm to 2%, all on a mass basis.

(Other Additives)

A sutable infrared absorbing dye appears in, for example, JP-A-2001-194522, and a suitable ultraviolet absorber appears in, fro example, JP-A-2001-151901. The amount of each of them in cellulose acylate is preferably from 0.001 to 5% by mass.

Minute particles preferably have an average size of 5 to 3000 nm and may be of a metal oxide or a crosslinked polymer, and the amount thereof in cellulose acylate is preferably from 0.001 to 5% by mass. The amount of a deterioration inhibitor in cellulose acylate is preferably from 0.0001 to 2% by mass.

A suitable optical anisotropy controller appears in, for example, JP-A-2003-66230 and JP-A-2002-49128 and the amount thereof in cellulose acylate is preferably from 0.1 to 15% by mass.

A sutable retardation improver is an aromatic compound having at least two aromatic rings, particularly a compound having 1,3,5-triazine rings, as described in, for example, EP0911656A2 or JP-A-2003-344655, and the amount thereof in cellulose acylate is preferably from 0.1 to 15% by mass.

(Film Forming by Melt Extrusion]

A mixture of the palletized cellulose acylate, plasticizer and any other additive is placed in the hopper of a melt extruder. The hopper temperature is preferably from 50° C. below the Tg of cellulose acylate to 30° C. above its Tg (hereinafter (Tg−50° C.) to (Tg+30° C.), this way of expression may apply to any other temperature range), more preferably from (Tg−40° C.) to (Tg+10° C.) and still more preferably from (Tg−30° C.) to Tg. This makes it possible to restrain any water re-adsorption to cellulose acylate in the hopper and achieve its effective drying easily.

The mixture is kneaded and melted at a temperature of from 120° C. to 250° C., preferably from 140° C. to 220° C. and more preferably from 150° C. to 200° C. Its kneading and melting may be carried out at a uniform temperature, or the extruder may have its temperature controlled in a plurality of ranges. Kneading time is preferably from 2 to 60 minutes, more preferably from 3 to 40 minutes and still more preferably from 4 to 30 minutes.

The melt extruder is preferably supplied with an inert gas when forming a film. The inert gas is preferably nitrogen. Such nitrogen preferably has a purity of 95% or higher, more preferably 99% or higher and still more preferably 99.5% or higher. The extruder preferably has a vent and is evacuated when forming a film.

The molten cellulose acylate is passed through a gear pump so that its pulsation caused by the extruder may be removed, and its filtration is carried out by e.g. a metal mesh filter or a sintered metal leaf disk. The filter preferably has a mesh size of from 2 to 30 μm, more preferably from 2 to 20 μm and still more preferably from 2 to 10 μm. Its filtration is preferably carried out at an elevated pressure so that filtration time may be shortened as far as possible. The filtration pressure is preferably from 0.5 to 15 MPa, more preferably from 2 to 15 MPa and still more preferably from 10 to 15 MPa. While a high pressure is desirable for a short filtration time, it is preferably within the range not causing any damage to the filter.

A filtration temperature of 180° C. to 230° C. is preferable, more preferably from 180° C. to 220° C. and still more preferably from 190° C. to 220° C. The filtration temperature not exceeding the upper limit stated above is preferable for avoiding any problem such as thermal deterioration and that which is not lower than the lower limit is desirable for avoiding any inconvenience such as thermal deterioration caused by too long a filtration time. It is desirable to shorten the filtration time as far as possible to prevent any yellowing of the film. The rate of filtration per cm² of filter and per minute is preferably from 0.05 to 100 cm³, more preferably from 0.1 to 100 cm³ and still more preferably from 0.5 to 100 cm³.

The filtered molten cellulose acylate is extruded in sheet form onto a cooling drum through a T-die installed after the Filter, Its extrusion may be in a single layer, or a multi-manifold die or a feed block die may be used to extrude a plurality of layers. Any unevenness in thickness of an extruded sheet along its width can be regulated by adjuting the distance of the lips of the die. Then, it is extruded onto a casting drum. The casting drum and the extruded sheet are preferably improved in their intimate contact by employing e.g. a method relying on the application of static electricity or a method employing an air knife, an air chamber, a vacuum nozzle or a touch roll. Such a method of improving their intimate contact may be applied to the whole surface of the extruded sheet, or only a part thereof. The casting drum preferably has a temperature of from 60° C. to 160° C., more preferably from 70° C. to 150° C. and still more preferably from 80° C. to 150° C.

The extrusion of the molten cellulose acylate through the die is preferably carried out in an inert gas atmosphere, too. The inert gas is preferably nitrogen. Such nitrogen preferably has a purity of 95% or higher, more preferably 99% or higher and still more preferably 99.5% or higher.

Then, the cellulose acylate in sheet form on the casting drum is separated therefrom and taken up past nip rolls. Its takeup speed is preferably from 10 to 100 m/min., more preferably from 15 to 80 m/min. and still more preferably from 20 to 70 m/min. The width of the film to be formed is from 1 to 5 m, preferably from 1.2 to 4 m and still more preferably from 1.3 to 3 m. The resulting film yet to be stretched preferably has a thickness of from 30 to 400 μm, more preferably from 40 to 300 μm and still more preferably from 50 to 200 μm.

The resulting sheet is preferably trimmed at both ends and taken up. The trimmed portions may be reused as a material for the same kind of film or for a different kind of film after crushing, and after palletizing, depolymerization and repolymerization, etc., if required. A laminar film is preferably applied to at least one side of the sheet to protect it from being scratched before it is taken up.

The cellulose acylate film of the present invention is preferably used as a protecting film for a polarizing plate, since it is excellent in thermal properties and in surface characteristics without showing any yellowing that is usually found on a film formed by melt extrusion, and without having any die line formed thereon.

When the unstretched cellulose acylate film of the present invention is used as a protecting film for a polarizing plate, its Re and Rth preferably satisfy the following relationships:

0≦Re≦15

0≦Rth≦60

more preferably

0≦Re≦12

0≦Rth≦55

still more preferably

0≦Re≦10

0≦Rth≦50

The Re and Rth retardation values as herein stated are calculated in accordance with the following expressions, in which Re and Rth represent an in-plane retardation of the film and retardation of a thickness direction of the film, respectively, at a wavelength λ:
Re(nm)=|nx−ny|×d
Rth(nm)=|[(nx+ny)/2]−nz|×d
wherein nx, ny and nz represent the refractive indexes of the film in the direction of its formation, along its width and across its thickness, respectively, and d represents its thickness (nm).

Re is determined by employing KOBRA-21ADH (an apparatus made by Oji Keisoku Kiki K.K.) and making light having a wavelength of λ nm fall on the film in the direction normal thereto. Rth is calculated by KOBRA-21ADH based on retardation values as determined in a plurality of directions including the Re value, a retardation value determined by employing a slow axis (determined by KOBRA-21ADH) as an axis of inclination (axis of rotation) and making light having a wavelength of λ nm fall on the film in a direction having an inclination of +40′ to the direction normal thereto and a retardation value determined by employing a slow axis in the film plane as an axis of inclination and making light having a wavelength of λ nm fall on the film in a direction having an inclination of −40° to the direction normal thereto. It is necessary to input the presumed value of the average refractive index and the film thickness. KOBRA-21ADH calculates nx, ny and nz in addition to Rth. While the average refractive index of cellulose acetate is 1.48, the values of other typical polymer films for optical use are, for example, 1.52 (cycloolefin polymer), 1.59 (polycarbonate), 1.49 (polymethyl methacrylate) and 1.59 (polystyrene). For the refractive indexes of other existing polymers, reference is made to Polymer Handbook (John Wiley & Sons, Inc.) and the catalogs of polymer films. The refractive index of any material which is unknown can be determined by using an Abbe's refractometer. The symbol λ as herein used represents 590±5 nm unless otherwise noted.

[Stretching]

According to the present invention, a mixed cellulose acylate film may be stretched to develop retardation. Its stretching is preferably carried out at a temperature of from Tg to (Tg+50° C.), more preferably from (Tg+1° C.) to (Tg+30° C.) and still more preferably from (Tg+2° C.) to (Tg+20° C.). Its stretching ratio is preferably from 10 to 300%, more preferably from 20 to 250% and still more preferably from 30 to 200%. Its stretching may be carried out in a single stage or in a multiplicity of stages. The stretching ratio is calculated by equation (A):
Stretching ratio(%)=100×Length after stretching/Length before stretching Equation (A)

Stretching is carried out by longitudinal stretching, transverse stretching and a combination thereof. Longitudinal stretching can be carried out by, for example,

(1) Roll stretching (stretching a film along its length by using two or more pairs of nip rolls having a higher peripheral velocity at the outlet) or

(2) Fixed end stretching (stretching a film along its length by holding it at both ends and conveying it along its length at a gradually higher speed). Transverse stretching may be carried out by, for example, tenter stretching (holding a film at both ends by chucks and stretching it transversely (at right angles to its length)).

Either longitudinal or transverse stretching may be employed alone (uniaxial stretching), or a combination of both (biaxial stretching). Longitudinal and transverse stretching may be carried out successively (successive stretching), or at the same time (simultaneous stretching). The rate for longitudinal or transverse stretching is preferably from 10 to 10,000%, more preferably from 20 to 1,000% and still more preferably from 30 to 800%, all on a per-minute basis, For multi-stage stretching, the above rate is the average of the rates of different stages. Stretching is preferably followed by 0 to 10% of longitudinal or transverse relaxation. Stretching is preferably followed also by one second to three minutes of heat setting at a temperature of 150° C. to 250° C.

Too high a stretching ratio causes a film to be fractured or torn. Such a stretching ratio is called breaking elongation. The breaking elongation is preferably from 150 to 300%, more preferably from 200 to 270% and still more preferably from 200 to 250% when stretching is carried out at a temperature 10° C. higher than the glass transition point of the film.

The in-plane retardation (Re) and the retardation of a thickness direction (Rth) which are developed by stretching are preferably in the relationship of Re≦Rth, more preferably Re×1.5≦Rth, and still more preferably Re×2≦Rth. Such Re and Rth relationship is preferably achieved by fixed end uniaxial stretching and more preferably by longitudinal and transverse biaxial stretching. Longitudinal and transverse stretching reduces a difference between the refractive indexes (n_{md} and n_{td}) in the film plane and thereby its Re value, and an enlarged area ratio of the film and a thickness reduction thereof by longitudinal and transverse stretching strengthen its orientation of a thickness direction and thereby increases its Rth value. Such Re and Rth make it possible to reduce any leakage of light at the time of black level of display.

The in-plane retardation of the film (Rd) is preferably from 0 to 300 nm, more preferably from 10 to 250 nm, still more preferably from 20 to 200 nm and most preferably from 50 to 100 nm. Its retardation of a thickness direction (Rth) is preferably from 0 to 500 nm, more preferably from 50 to 400 nm, still more preferably from 80 to 350 nm and most preferably from 150 to 250 nm.

The cellulose acylate film as stretched preferably has a thickness of from 10 to 300 μm, more preferably from 20 to 200 μm and still more preferably from 30 to 100 μm.

The angle θ between the direction of film forming (along the length of the film and the slow axis of its Re is preferably 0° or 90° or as close to 90° as possible. More specifically, it is preferably as close to 0° as possible in the case of longitudinal stretching and is preferably 0±3°, more preferably 0±2° and still more preferably 0±1°. In the case of transverse stretching, it is preferably 90±3° or 90±3°, more preferably 90±2° or 90±2° and still more preferably 90±1° or 90±1°.

An unstretched or stretched cellulose acylate film may be used alone, or in combination with a polarizing plate, or a liquid crystal layer, a layer having a controlled refractive index (low reflection layer) or a hard coat layer may be formed thereon.

[Thermal Characteristics of Film]

The cellulose acylate optical film of the present invention has such thermal characteristics that when it is formed by melt extrusion, it is not deteriorated by heat, or its thermal deterioration is limited to a minimum. More specifically, when cellulose acylate is melted for 20 minutes at a temperature 10° C. higher than its melting point in an inert gas atmosphere in which it is not substantially affected by oxygen or water, its number-average and weight-average molecular weights (or its polymerization degree) are preferably lowered only by 30% or less, more preferably by 25% or less and still more preferably by 20% or less. The inert gas atmosphere may be replaced by a vacuum having a pressure of 10 mm Hg or less.

[Characteristics in Shape of Film]

The film of the present invention is restrained in yellowing and the amount of minute foreign matter and has excellent characteristics in surface conditions, etc.

[Yellowing]

The yellowing of a cellulose acylate film can be strictly determined by absorptiometry, though it can also be checked visually. More specifically, the absorbance of light having a wavelength of 400 nm by a film is determined when it has a thickness of 100 μm. Its absorbance has to be from 0 to 0.004, preferably from 0 to 0.0035 and more preferably from 0 to 0.003. The absorbance by a film having a different thickness is proportional to its thickness and can be converted to the value by a film having a thickness of 100 μm if the result of measurement is divided by the thickness of the film and is multiplied by 100.

[Surface Conditions]

The surface conditions of a cellulose aclate film can be strictly determined by a surface roughness measuring instrument, though they can also be checked visually. Its surface roughness has to be 0.2 μm or less, preferably 0.15 μm or less and more preferably 0.1 μm or less.

[Minute Polarizing Foreign Matter]

The evaluation of a cellulose acylate film for minute foreign matter may be made by examining a given 1-mm square area of the film through a polarizing microscope and counting its particles as observed. When the film has a thickness of 50 μm, the number of particles of minute foreign matter having a length of 10 μm or less to be observed has to be 5 or less, preferably 3 or less, more preferably 2 or less and most preferably 0. The number of the particles is per (mm²×50 μm), i.e. (5×10⁻² mm³). Although it is likely that particles of minute foreign matter having a length over 10 μm may also be contained, only particles having a length of 10 μm or less are checked according to the present invention, since the number of the former particles is substantially proportional to that of the latter. For a film having a different thickness, the number of particles per (5×10⁻² mm³) may be obtained by conversion from those in a film having a thickness of 50 μm.

[Surface Treatment]

The surface treatment of a mixed cellulose acylate film is sometimes effective for providing an improved adhesion between it and any functional layer (for example, an undercoat or backup layer). Examples are glow discharge treatment, ultraviolet irradiation, corona treatment, flame treatment and acid or alkali treatment.

Glow discharge treatment is preferably carried out by treatment with a low-temperature plasma occurring at a low gas pressure of 10⁻³ to 20 torr or by plasma treatment at an atmospheric pressure. Plasma-excitable gas is gas excited into a plasma under such conditions, for example, argon, helium, neon, krypton, xenon, nitrogen, carbon dioxide, tetrafluoromethane or any other Freon, or a mixture thereof. Details thereof are stated in Published Technical Report of The Hatsumei Kyokai (Association of Inventions) (Report No. 2001-1745, published on Mar. 15, 2001 by Hatsumei Kyokai), pages 30 to 32. The atmospheric pressure plasma treatment which has recently been drawing attention employs, for example, from 20 to 500 Kgy of irradiation energy at 10 to 1,000 Kev and preferably from 20 to 300 Kgy of irradiation energy at 30 to 500 Kev. Alkali saponification treatment is particularly preferable among those methods of film surface treatment and is very effective for the surface treatment of a mixed cellulose acylate film.

[Alkali Saponification Treatment]

The alkali saponification treatment of a cellulose acylate film may be effected by dipping the film in a saponifying solution or coating it with the solution. The dipping method may be carried out by passing a film for a period of 0.1 to 10 minutes through a tank containing an aqueous solution of e.g. NaOH or KOH having a pH of 10 to 14 and a temperature of 20° C. to 80° C., neutralizing it, washing it with water and drying it.

The coating method may be carried out by dip coating, curtain coating, extrusion coating, bar coating or E type coating. A coating solution for alkali saponification treatment is preferably prepared by selecting a solvent which improves the wetting property of the saponifying solution on the film and maintains its surface in a good condition without forming any unevenness thereon. More specifically, an alcoholic solvent is preferable and isopropyl alcohol is particularly preferable. An aqueous solution of a surface active agent can also be used as a solvent.

The alkali in the coating solution for alkali saponification is preferably one soluble in the solvent and KOH or NaOH is particularly preferable. The coating solution preferable has a pH of 10 or higher and more preferably 12 or higher. The reaction of alkali saponification is preferably carried out for a period of from one second to five minutes, more preferably from five seconds to five minutes and still more preferably from 20 seconds to three minutes, all at room temperature. The reaction of alkali saponification is preferably followed by washing with water the surface coated with the saponifying solution, or by washing it with an acid and thereafter with water. These methods of saponification are specifically described in, for example, JP-A-2002-82226 and International Publication No. 02/46809.

An undercoat layer is preferably formed for adhesion to a functional layer, The undercoat layer may be formed after the above surface treatment or without any surface treatment. For details of the undercoat layer, reference is made to Published Technical Report of The Hatsumei Kyokai (Association of Inventions) (Report No. 2001-1745, published on Mar. 15, 2001 by Hatsumei Kyokai), page 32.

The surface treatment and the formation of the undercoat layer may be incorporated in the final stage of the film-forming process, or may be carried out independently, or may be carried out in a process for forming a functional layer as will be described below.

[Combination with a Functional Layer]

The mixed cellulose acylate film of the present invention is preferably combined with functional layers as described in detail in Published Technical Report of The Hatsumei Kyokai (Association of Inventions) (Report No. 2001-1745, published on Mar. 15, 2001 by Hatsumei Kyokai), pages 32 to 45. It is particularly preferable to form a polarizing layer to make a polarizing plate. The following is a description of a combination of the film and a polarizing layer:

[Polarizing Layer]

(Raw Materials for a Polarizing Layer)

A polarizing plate can be made by e.g. bonding a polarizing film to a cellulose acylate film of the present invention to form a polarizing layer thereon.

A polarizing film which is now commercially available is usually made by dipping a stretched polymer in a solution of iodine or a dichroic dye in a bath so that iodine or a dichroic dye may penetrate through the polymer. A coating type polarizing layer, typically of Optiva Inc., can also be used as a polarizing layer. The iodine or dichroic dye in the polarizing film is aligned in the polymer forming the polarizing film to exhibit a polarizing performance. An azo, stilbene, pyrazolone, triphenylmethane, quinoline, oxazine, thiazine or anthraquinone dye is used as the dichroic dye. The dichroic dye is preferably water-soluble. The dichroic dye preferably has a hydrophilic substituent group (for example, a sulfo, amino or hydroxyl group). Examples of compounds are found in Published Technical Report of The Hatsumei Kyokai (Association of Inventions) (Report No, 2001-1745, published on Mar. 15, 2001 by Hatsumei Kyokai), page 58.

The polymer forming the polarizing film may be a polymer which is itself cross-linkable, or a polymer which is cross-linkable by a cross-linking agent, or any of a plurality of combinations thereof. Examples of suitable polymers are methacrylate copolymers, styrene copolymers, polyolefins, polyvinyl alcohols and modified polyvinyl alcohols, poly(N-methylolacrylamide), polyesters, polyimides, vinyl acetate copolymers, carboxymethyl cellulose and polycarbonates as listed in paragraph [0022] of JP-A-H8-338913. A silane coupling agent can be used as a polymer. Water-soluble polymers, such as poly(N-methylolacrylamide), carboxymethyl cellulose, gelatin, polyvinyl alcohols or modified polyvinyl alcohols, are preferable, gelatin, polyvinyl alcohols and modified polyvinyl alcohols are more preferable, and polyvinyl alcohols and modified polyvinyl alcohols are most preferable. It is particularly preferable to use together two kinds of polyvinyl alcohols or modified polyvinyl alcohols having different degrees of polymerization.

It is preferable to use polyvinyl alcohols having a saponification degree of from 70 to 100% and more preferably from 80 to 100%. The preferred polymerization degree thereof is from 100 to 5,000. For modified polyvinyl alcohols, reference is made to JP-A-H8-338913, JP-A-H9-152509 and JP-A-H9-316127. Two or more kinds of polyvinyl alcohols or modified polyvinyl alcohols may be used together.

The polarizing film preferably has a thickness of 10 μm or more. As regards the upper limit of its thickness, a smaller thickness is better for avoiding the leakage of light from a liquid crystal display device, and it is preferably equal to or less than the thickness of a commercially available polarizing plate (about 30 μm), more preferably 25 μm or less and still more preferably 20 μm or less. The polymer for forming a polarizing film may be a cross-linked one. A polymer or monomer having a cross-linking functional group may be mixed in the polymer for a polarizing film, or a cross-linking functional group may be given to the polymer itself. Its cross-linking may be effected by applying light or heat, or making a pH change to form a polymer having a cross-linked structure. For the cross-linking agent, reference is made to U.S. Reissue Pat. No. 23,297. A boron compound, such as boric acid or borax, can be used as a cross-linking agent, too. The amount of the cross-linking agent to be added to the polymer is preferably from 0.1 to 20% by mass thereof. This makes it possible to form a polarizing film improved in alignment and wet heat resistance. When a cross-linking reaction has ended, the amount of any unreacted cross-linking agent is preferably 1.0% by mass or less and more preferably 0.5% by mass or less. This makes it possible to form a polarizing film of improved weatherability.

(Stretching of Polarizing Film)

A polarizing film is preferably dyeing with iodine or a dichroic dye after stretching a polymer film for forming a polarizing film (stretching method) or rubbing it (rubbing method). When the stretching method is employed, its stretching ratio is preferably from 2.5 to 30.0 times and more preferably from 3.0 to 10.0 times. Dry stretching in the air may be employed. It is also possible to employ wet stretching by dipping a film in water. Its dry stretching ratio is preferably from 2.5 to 5.0 times and its wet stretching ratio is preferably from 3.0 to 10.0 times. Its stretching may be effected in parallel to its MD direction (parallel stretching), or in an inclined direction (inclined stretching). Its stretching may be completed at a time, or may be carried out several times progressively. Progressive stretching enables uniform stretching even at a high stretching ratio. Inclined stretching at an angle of 10 to 80 degrees is more preferable. The following is a description of the stretching methods:

(a) Parallel Stretching

A PVA film is swollen before stretching. Its swelling degree is from 1.2 to 2.0 times when a swollen film is compared in weight with the film yet to be swollen. Then, it is stretched in a bath containing an aqueous medium or a solution of a dichroic dye and having a temperature of from 15° C. to 50° C. and preferably from 17° C. to 40° C., while it is continuously conveyed by guide rolls, etc. Its stretching can be achieved by holding it by two pairs of nip rolls and operating the latter pair of nip rolls at a higher conveying speed than that of the former. Its stretching ratio is the ratio in length of the stretched film to the original film and is preferably from 1.2 to 3.5 times and more preferably from 1.5 to 3.0 times in view of the performance and advantages as stated above. Then, it is dried at a temperature of 50° C. to 90° C. to yield a polarizing film.

(b) Inclined Stretching

Inclined stretching may be carried out by employing a method using a tenter extending in an inclined direction as described in JP-A-2002-86554. This stretching is carried out in the air and requires a film to contain water so that its stretching may be easier. Its water content is preferably from 5 to 100% and more preferably from 10 to 100%. Its stretching temperature is preferably from 40° C. to 90° C. and more preferably from 50° C. to 80° C. Its stretching relative humidity is preferably from 50 to 100%, more preferably from 70 to 100% and still more preferably from 80 to 100%. Its longitudinal travel speed is preferably 1 m/min. or higher and more preferably 3 m/min. or higher. The stretched film is preferably dried for 0.5 to 10 minutes at a temperature of from 50° C. to 100° C. and more preferably from 60° C. to 90° C. Its drying time is more preferably from one to five minutes. The resulting polarizing film preferably has an absorption axis of from 10° to 80°, more preferably from 30° to 600 and still more preferably substantially 45° (40° to 50°).

(Bonding a Cellulose Acylate Film and a Polarizing Film Together to Form a Polarizing Plate)

An unstretched cellulose acylate film according to the present invention and a stretched one can both be employed as a protecting film for a polarizing film. A stretched cellulose acylate film according to the present invention can be used as a film functioning as a protective film for a polarizing film. It is preferably used as a film performing a retardation compensating function, too.

It is preferable to make a polarizing plate having any of the structural compositions as listed below. Any of Fujitac TD80, TD80U and TD80UF, products of Fuji Film Co., Ltd., can, for example, be used as an unstretched cellulose triacetate film.
Polarizing plate A: An unstretched cellulose acylate film/a polarizing film/an unstretched cellulose triacetate film;
Polarizing plate B: An unstretched cellulose acylate film/a polarizing film/an unstretched cellulose acylate film;
Polarizing plate C: A stretched cellulose acylate film/a polarizing film/an unstretched cellulose triacetate film;
Polarizing plate D: A stretched cellulose acylate film/a polarizing film/an unstretched cellulose acylate film;
Polarizing plate E: A stretched cellulose acylate film/a polarizing film/a stretched cellulose acylate film.

An unstretched or stretched cellulose acylate film as saponified above and a polarizing film formed by stretching are bonded together, whereby a polarizing layer is formed on the cellulose acylate film to thereby make a polarizing plate. They are bonded together so that the casting direction of the cellulose acylate film and the stretching direction of the polarizing film may have an angle of 0°, 45° or 90°, and preferably 0°, at which they are parallel to each other. Any adhesive can be used for bonding them together, and a PVA resin (including a modified PVA, such as an acetoacetyl, sulfonate, carboxyl or oxyalkylene group) and an aqueous solution of a boron compound are, for example, available, though a PVA resin is preferred. An adhesive layer preferably has a dry thickness of from 0.01 to 10 μm and more preferably from 0.05 to 5 μm.

The polarizing plate preferably has a high light transmittance and a high polarization degree. It preferably has a transmittance of 30 to 50%, more preferably 35 to 50% and still more preferably 40 to 50% to light having a wavelength of 550 nm. Its polarization degree is preferably from 90 to 100%, more preferably from 95 to 100% and still more preferably from 99 to 100% to light having a wavelength of 550 nm. The polarizing plate may be stacked with a λ/4 plate to form a circular polarization of light. They are so stacked together that the slow axis of the λ/4 and the absorption axis of the polarizing plate may have an angle of 45° therebetween. While the λ/4 is not specifically limited, it preferably has such a wavelength dependence that low retardation may depend on a low wavelength. Moreover, it is preferable to use a polarizing film having an absorption axis inclined at an angle of 20° to 70° to its length and a λ/4 plate composed of an optically anisotropic layer formed from a liquid crystal compound.

### EXAMPLES

The outstanding features of the present invention will now be described more specifically based on examples and comparative examples. The materials, amounts thereof, proportions thereof, details of treatment, procedures thereof, etc. as will be set forth in the following description of examples may be modified or altered as desired without departing from the scope and spirit of the present invention. Therefore, the scope of the present invention is not to be limited by any of the specific examples which will now be given.

[Synthesis of Cellulose Acylate]

Cellulose acylate was synthesized as described below.

### Synthesis Example 1

A 3-liter separable flask was charged with 250.0 g of cut hardwood pulp cellulose and 125.0 g of acetic acid. It was filled with nitrogen gas and its contents were stirred for four hours at an ambient temperature of 40° C. The resulting cellulose swollen with acetic acid was cooled in an ice bath.

A mixture of acylating agents, which had been prepared from 163.0 g of acetic acid, 138.8 g of acetic acid anhydride, 1,336.5 g of butyric acid, 1,200.0 g of butyric acid anhydride and 12.5 g of sulfuric acid and cooled to −20° C. or below, was added to the flask at a time. After half an hour, the ice bath was removed and the flask had its internal temperature raised to 18° C. in 1.5 hours and maintained at 18° C. until the end of the reaction.

After the reaction product had become clear, 925.3 g of cooled acetic acid and a mixture of 220.0 g of acetic acid and 219.7 g of water were dropped into the reaction product at an ambient temperature of 5° C. The flask had its internal temperature held at 25° C. or below. Their dropping was followed by temperature elevation to 60° C. under stirring. Then, 225.0 g of magnesium acetate 4-hydrate, acetic acid and water (1/1/1) was dropped into the flask. After it was cooled, its contents were diluted with five liters of acetic acid and 25 liters of acetic acid and water (3:1) and the dilution was subjected to twice of filtration under pressure by a 10 μm filter. The resulting solution was supplied with 15 liters of water, whereby a white precipitate was obtained. The white precipitate was filtered to have any solution removed therefrom. The white precipitate was washed with 25 liters of water and with 25 liters of warm water having a temperature of 80° C. twice. Then, it was stirred for an hour in 25 liters of a 0.005% aqueous solution of calcium hydroxide to have any solution removed therefrom and was washed thoroughly with water. The resulting white precipitate was subjected to centrifugal separation to have any water removed therefrom, and finally to vacuum drying at a temperature of 80° C. There was obtained cellulose acetate butyrate (CAB1) as a white solid weighing 428 g.

### Synthesis Example 2

Synthesis Example 1 was repeated except that its acylation reaction temperature was changed to 28° C. There was obtained CAB2 weighing 383 g.

### Synthesis Example 3

Synthesis Example 1 was repeated except that the acylation, addition of acetic acid and water and temperature elevation to 60° C. therein were followed by four hours of reaction. There was obtained CAB3 weighing 420 g.

### Synthesis Example 4

Synthesis Example 2 was repeated except that the acylation, addition of acetic acid and water and temperature elevation to 60° C. therein were followed by four hours of reaction. There was obtained CA54 weighing 380 g.

### Synthesis Example 5

In a 5-liter separable flask used as a reaction vessel and having a reflux device, 150 g of cellulose (hardwood pulp) and 75 g of acetic acid were violently stirred for two hours, while the flask was heated in an oil bath having a controlled temperature of 60° C. This pretreatment swelled and crushed the cellulose and made it fluffy. The reaction vessel was left to stand for 30 minutes in an iced water bath having a temperature of 2° C. and was thereby cooled.

An acylating agent was prepared by mixing 1,545 g of propionic acid anhydride and 10.5 g of sulfuric acid, was cooled to −30° C. and was added at a time into the reaction vessel containing the pretreated cellulose. After 30 minutes, the external temperature was elevated so gradually that an internal temperature of 25° C. might be reached two hours after the addition of the acylating agent. The reaction vessel was cooled in an iced water bath having a temperature of 5° C. so that its internal temperature may be 10° C. 0.5 hour after the addition of the acylating agent and 23° C. two hours thereafter, and its internal temperature was held at 23° C. for three hours of further stirring. The reaction vessel was cooled in an iced water bath having a temperature of 5° C. and 120 g of acetic acid containing 25% by mass of water and cooled to 5° C. was added thereinto in an hour. Its internal temperature was raised to 60° C. and stirring was continued for four hours. Then, a solution obtained by dissolving twice as many moles of magnesium acetate tetrahydrate as sulfuric acid in acetic acid containing 50% by mass of water was added into the reaction vessel and its contents were stirred for six hours at 60° C. One liter of acetic acid containing 25% by mass of water, 500 ml of acetic acid containing 33% by mass of water, one liter of acetic acid containing 50% by mass of water and one liter of water were added successively in their order, whereby cellulose acetate propionate was precipitated. The precipitate of cellulose acetate propionate was washed with warm water. After its washing, it was stirred for 0.5 hour in an aqueous solution of calcium hydroxide having a concentration of 0.005% by mass and a temperature of 20° C., and after it was further washed with water until waste water had a pH of 7, it was dried at 70° C. in a vacuum to yield cellulose acetate propionate (CAP1).

[Structural Analysis of Cellulose Acylate]

[Structural Analysis]

Table 1 shows the physical properties of CAB1 to CAB4 and CAP1 as synthesized in Synthesis Examples 1 to 5, respectively, and Eastman Chemical's products, CAB381-20 and CAP482-20.

The acetyl, propionyl, butyryl and total substitution degrees of each sample were determined by ¹H NMR spectroscopy (in chloroform-d). The molecular weights of the repeating units were calculated from the values of those substitution degrees.

The number-average and weight-average molecular weights were determined by gel-permeation chromatography (using tetrahydrofuran as a developing solvent, and based on polystyrene standards) and were divided by the molecular weights of the repeating units to calculate the number-average and weight-average polymerization degrees.

The melting point of each sample was determined by a melting-point measuring instrument. The temperature at which complete melting occurred was taken as the melting point.

The results are shown in Table 1.

TABLE 1

| | Butyryl or | | | Number- | Weight- | | |
|---|---|---|---|---|---|---|---|
| | propionyl | Acetyl | | average | average | | |
| Cellulose | substitution | substitution | Total substitution | polymerization | polymerization | Melting | |
| acylate | degree | degree | degree | degree | degree | point | Remarks |
| CAB1 | 1.80 | 1.10 | 2.90 | 310 | 772 | 200° C. | Synthesis |
| | | | | | | | Example 1 |
| CAB2 | 1.79 | 1.10 | 2.89 | 142 | 393 | 185° C. | Synthesis |
| | | | | | | | Example 2 |
| CAB3 | 1.69 | 1.00 | 2.69 | 250 | 730 | 202° C. | Synthesis |
| | | | | | | | Example 3 |
| CAB4 | 1.68 | 1.01 | 2.69 | 132 | 380 | 191° C. | Synthesis |
| | | | | | | | Example 4 |
| CAB381-20 | 1.67 | 1.01 | 2.68 | 216 | 724 | 197° C. | Product of |
| | | | | | | | Eastman |
| | | | | | | | Chemical |
| CAP1 | 2.52 | 0.15 | 2.67 | 234 | 802 | 243° C. | Synthesis |
| | | | | | | | Example 5 |
| CAP482-20 | 2.50 | 0.16 | 2.66 | 220 | 851 | 240° C. | Product of |
| | | | | | | | Eastman |
| | | | | | | | Chemical |

[Forming a Cellulose Acylate Film by Melt Casting]

### Example 1

A film of CAB1 was formed by melt casting.

(1) Pelletization

CAB1 was dried at 100° C. for three hours until it had a water content of 0.1% by mass. It was placed in a hopper on a twin-screw kneading extruder in the air and kneaded at a temperature of 200° C. with a screw rotating speed of 200 rpm and a dwell time of 80 seconds. The molten material was extruded to form strands having a diameter of 3 mm in a water bath having a temperature of 40° C. and after the strands were solidified by one minute of immersion, they were cooled by passing through water having a temperature of 10° C. for 30 seconds and were cut into pellets having a length of 5 mm. The pellets were dried at 100° C. for 10 minutes and packed in bags.

(2) Film Forming

The pellets were dried for three hours in a vacuum drier having a temperature of 110° C. Then, they were placed in the hopper in the air and melted at 220° C. and the molten material was filtered at a pressure of 10 MPa by using a 5-μm sintered metal filter. A film having a thickness of 150 μm was formed from the molten CAB1 by employing a T/D ratio of 4 (the ratio of the lip distance and the thickness of the film to be formed) and a distance of 10% between a casting drum (CD) and a die (the CD and die distance divided by the film width and expressed in percentage). After a solidified film was separated and trimmed at both edges by 5% of its width at each edge) immediately prior to take-up, it was knurled at both edges to have a protrusion having a width of 10 mm and a height of 50 μm at each edge and was taken up for a length of 10 m at a rate of 30 m/min. The sample film as obtained was examined by ¹H-NMR spectroscopy and GPC, whereby its substitution and polymerization degrees were determined.

(3) Stretching (for Determining Breaking Elongation)

The film as obtained at (2) was stretched in the TD direction at a temperature 10° C. higher that its Tg and at a rate of 100% per minute, whereby its breaking elongation was determined. It was further stretched in the same way until immediately prior to breaking, whereby a stretched film was obtained.

### Example 2

Example 1 was repeated except that steps (1) and (2) were carried out in a nitrogen gas atmosphere.

### Example 3

Example 1 was repeated except that CAB1 was replaced by CAB2.

### Example 4

Example 2 was repeated except that CAB1 was replaced by CAB2.

### Example 5

Example 1 was repeated except that CAB1 was replaced by CAB3.

### Example 6

Example 2 was repeated except that CAB1 was replaced by CAB3.

### Example 7

Example 1 was repeated except that CAB1 was replaced by CAB4.

### Example 8

Example 2 was repeated except that CAB1 was replaced by CAB4.

### Example 9

Example 1 was repeated except that CAB1 was replaced by CAB381-20.

### Example 10

Example 2 was repeated except that CAB1 was replaced by CAB381-20.

### Example 11

Example 2 was repeated for forming a film by melt extrusion and casting except for the replacement of CAB1 by CAB381-20 and the addition of 6% of a compound having the structure shown below as described in JP-A-2003-344655. A stretching ratio of 140% was employed.

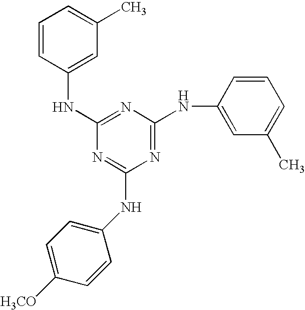

### Example 12

Example 2 was repeated except that CAB1 was replaced by CAP1, and that a melting temperature of 245° C. was employed.

### Example 13

Example 2 was repeated except that CAB1 was replaced by CAP482-20, and that a melting temperature of 245° C. was employed.

[Evaluation of Cellulose Acylate Films]

(Yellowing)

A sample of each cellulose acylate film as described above was examined for its absorbance of light with a wavelength of 400 nm and thereby for yellowing. A visually ascertainable threshold value of 0.004 was adopted for a film having a thickness of 100 μm. Any value above it was considered as indicating the presence of yellowing and any value below it was taken as indicating the absence of yellowing. The absorbance of any film having a different thickness was compared with that of a film having a thickness of 100 μm, since its absorbance was proportional to its thickness.

(Die Line)

A sample of each cellulose acylate film was visually inspected for any die line.

(Re and Rth)

After each film sample was left to stand at a temperature of 25° C. and a relative humidity of 60% for at least three hours for moisture control, its Re was calculated at a temperature of 25° C. and a relative humidity of 60% by using an automatic birefringence meter, KOBRA-21ADH/PR, a product of Oji Keisoku Kiki K.K.

(Thermal Characteristics of Film)

A sample weighing 20 mg of each of the films formed according to Examples 1 to 13 as described at (2) of Example 1 and not stretched as described at (3) was placed in a 10-mL sample tube and heated for 20 minutes at a temperature 10° C. higher than its melting point. After its heating, it was checked for its number-average and weight-average polymerization degrees by GPC. Those values were divided by the number-average and weight-average polymerization degrees of the film yet to be heated and a reduction thereof was calculated.

(Substitution Degree of Film)

The films formed according to Examples 1 to 13 as described at (2) of Example 1 and not stretched as described at (3) was examined by ¹H-NMR spectroscopy and all gave the same values with the starting cellulose acylate. Residual solvent in the films is not detected.

The results are shown in Table 2.

TABLE 2

| | | | Reduction | Reduction | | | | | | | |
|---|---|---|---|---|---|---|---|---|---|---|---|
| | | | in number- | in weight- | | | | | | | |
| | | | average | average | | | | | | | |
| | Starting | | polymerization | polymerization | | | | | | | |
| | cellulose | Melting | degree by | degree by | Braeking | Film | | Die | Re | | |
| | acylate | atmosphere | heating | heating | Elongation | thickness | Yellowing | line | [nm] | Rth [nm] | Remarks |
| Example 1 | CAB1 | air | 45%% | 41% | 120% | 70 μm | Yes | Yes | 34 | 133 | Com. Ex. |
| Example 2 | CAB1 | nitrogen | 40% | 37% | 145% | 60 μm | Yes | Yes | 45 | 142 | Com. Ex. |
| Example 3 | CAB2 | air | 48% | 51% | 120% | 70 μm | Yes | Yes | 34 | 133 | Com. Ex. |
| Example 4 | CAB2 | nitrogen | 46% | 42% | 145% | 60 μm | Yes | Yes | 45 | 142 | Com. Ex. |
| Example 5 | CAB3 | air | 17% | 21% | 220% | 50 μm | No | No | 74 | 223 | Invention |
| Example 6 | CAB3 | nitrogen | 13% | 10% | 240% | 45 μm | No | No | 80 | 235 | Invention |
| Example 7 | CAB4 | air | 25% | 28% | 190% | 55 μm | No | No | 67 | 206 | Invention |
| Example 8 | CAB4 | nitrogen | 17% | 13% | 200% | 52 μm | No | No | 69 | 210 | Invention |
| Example 9 | CAB381-20 | air | 19% | 23% | 235% | 47 μm | No | No | 81 | 237 | Invention |
| Example 10 | CA3381-20 | nitrogen | 15% | 13% | 245% | 40 μm | No | No | 84 | 245 | Invention |
| Example 11 | CAB381-20 | nitrogen | 25% | 27% | Note | 65 μm | No | No | 80 | 235 | Invention |
| Example 12 | CAP1 | nitrogen | 27% | 29% | 170% | 65 μm | No | No | 45 | 132 | Invention |
| Example 13 | CAP482-20 | nitrogen | 45% | 50% | 150% | 60 μm | Yes | Yes | 36 | 120 | Com. Ex. |

Note:
The film according to Example 11 did not break until a stretching ratio of 140%. No higher stretching ratio was tested.

As is obvious from the results shown above, the cellulose acylate films falling within the scope of the present invention exhibit a high level of retardation. Moreover, they are free from any coloring or die line. On the other hand, the films not falling within the scope of the present invention have a low breaking elongation, exhibit only a low level of retardation, are colored and have die lines.

[Manufacture of a Polarizing Plate—1]

(1) Saponification of a Cellulose Acylate Film

A sample of the cellulose acylate film according to Example 10 was saponified as stated below. An aqueous solution containing 2.5 moles of NaOH per liter was prepared as a saponifying solution and heated to 60° C., and the film sample was dipped therein and left to stand for two minutes. Then, it was dipped in an aqueous solution containing 0.05 mole of sulfuric acid per liter, and after 30 seconds, it was passed through a water washing bath.

(2) Manufacture of a Polarizing Plate

A polyvinyl alcohol film having a thickness of 75 μm, 9X75RS of Kuraray Corp., was stretched longitudinally by employing two pairs of nip rolls having different peripheral velocities in accordance with Example 1 in JP-A-2001-141926.

(3) Bonding

The resulting polarizing film and the saponified cellulose acylate film were bonded together by using an aqueous solution containing 3% by mass of polyvinyl alcohol, PVA-117H of Kuraray Corp., as an adhesive in such a way that the stretching direction of the polarizing film and the film-forming direction of the cellulose acylate film might be parallel to each other to form a polarizing plate having a layer structure composed of a stretched cellulose acylate film, a polarizing film and an unstretched cellulose acylate film. The unstretched cellulose acylate film was a film yet to be stretched.

(4) Manufacture of a Liquid Crystal Display Device

The polarizing plate as described was substituted for the polarizing plate in a 15-inch display, VL-1530S (VA type) of Fujitsu K.K., whereby a good image was obtained.

[Manufacture of a Polarizing Plate—2]

(1) Preparation of an Unstretched Cellulose Acylate Film

(1-1) Pelletization

Cellulose acylates as shown in Table 3 were synthesized by repeating Synthesis Example 5, but changing the acetyl and propionyl proportions in the acylating agent (a mixture of acetic acid and propionic acid anhydride). Each cellulose acylate was dried by air at 120° C. for three hours until it had a water content of 0.1% by mass. It was mixed with the plasticizer as shown in Table 3, 0.05% by mass of silicon dioxide particles (Aerozyl R972V), 0.20% by mass of a phosphate stabilizer (P-1), 0.8% by mass of an ultraviolet absorber a [2,4-bis-(n-octylthio)-6-(4-hydroxy-3,5-di-tert-butylanilino)-1,3,5-triazine] and 0.25% by mass of an ultraviolet absorber b [2(2′-hydroxy-3′,5′-di-tert-butylphenyl)-5-chloro-benzotriazole] and their mixture was kneaded for melting at 190° C. by a twin-screw kneading extruder. The extruder had a vent for evacuating it to a pressure of 0.3 atmosphere. The molten material was extruded to form strands having a diameter of 3 mm in a water bath and the strands were cut to form pellets having a length of 5 mm. 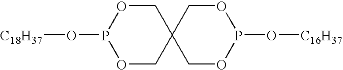
(1-2) Film Forming by Melt Casting

The cellulose acylate pellets as prepared were dried by a vacuum drier at 100° C. for three hours. They were placed in a hopper having a temperature controlled to (Tg−10)° C. and the molten cellulose acylate was extruded in a nitrogen gas atmosphere by employing a single-screw extruder and a screw having a compression ratio of 4.0. The screw had a temperature of from 180° C. to 195° C. in its upper feeding portion, from 200° C. to 210° C. in its middle compressing portion and from 210° C. to 235° C. in its lower metering portion.

Then, a molten resin delivered by a gear pump was filtered by a leaf disk filter having a filtering accuracy of 5 μm, was extruded from a hanger coat die through a static mixer and was cast onto a casting drum. A 3 kV electrode was installed 5 cm apart from the resin to give electrostatic treatment to each edge having a width of 5 cm. The resin was solidified past three casting drums having temperatures set at (Tg−5)° C., Tg and (Tg−10)° C., respectively, and each having a diameter of 60 cm to give a cellulose acylate film having a thickness as stated in Table 3. It was trimmed by a width of 5 cm at both edges and knurled to form a protrusion having a width of 10 mm and a height of 50 μm at each edge. A film having a width of 1.5 m and a wound length of 100 m was formed from each material at a film-forming speed of 30 m/min.

Each unstretched cellulose acylate film as obtained as examined for yellowing, Re and Rth and the results are shown in Table 3. The other physical properties included a haze of 0.10% and a transparency of 93.1%. The film did not have any bright point or foreign matter or any die line or unevenness on its surface, but had an excellent surface and excellent properties for optical use.

(2) Manufacture of a Polarizing Plate

(2-1) Saponification of a Cellulose Acylate Film

The cellulose acylate film was saponified by a dipping method as stated below. An aqueous solution containing 2.5 moles of NaOH per liter was prepared as a saponifying solution and heated to 60° C., and the film was dipped therein and left to stand for two minutes. Then, it was dipped in an aqueous solution containing 0.025 mole of sulfuric acid per liter, and after 30 seconds, it was washed with water.

(2-2) Manufacture of a Polarizing Plate

A polyvinyl alcohol film having a thickness of 75 μm, 9X75RS of Kuraray Corp., was stretched longitudinally by employing two pairs of nip rolls having different peripheral velocities in accordance with Example 1 in JP-A-2001-141926, whereby a polarizing film having a thickness of 20 μm was obtained.

(2-3) Bonding

The resulting polarizing film, the saponified unstretched and stretched cellulose acylate films and a saponified Fujitac TD80U film (an unstretched triacetate film of Fuji Film Co., Ltd.) were bonded together by using an aqueous solution containing 3% by mass of polyvinyl alcohol, PVA-117H of Kuraray Corp., as an adhesive in such a way that the stretching direction of the polarizing film and the film-forming direction of the cellulose acylate film might be parallel to each other to form a polarizing plate having a layer structure composed of an unstretched cellulose acylate film, a polarizing film and a Fujitac TD80U film for a polarizing plate A and an unstretched cellulose acylate film, a polarizing film and an unstretched cellulose aclate film for a polarizing plate B.

(3) Package Evaluation

One polarizing plate closer to the viewer was separated from the two polarizing plates having a liquid crystal layer sandwiched therebetween in each of 26-inch and 40-inch liquid crystal display units (products of Sharp Corp.) including VA type liquid crystal cells and the polarizing plate A or B as described above was bonded thereto by an adhesive. Liquid crystal display units were fabricated by positioning the transmission axis of the polarizing plate closer to the viewer and that of the polarizing plate on the backlight side when each such liquid crystal display unit was used for a totally gray display, visible streaks of unevenness in the display were counted and the numbers thereof are shown in Table 3.

The liquid crystal display units having polarizing plates made by using cellulose acylate films according to the present invention hardly showed any streak of unevenness in a display, but were very good liquid crystal display units producing a uniformly visible display all over its screen. The use of films departing from the scope of the present invention resulted in streaks making a markedly uneven display.

(4) Forming a Low Reflection Film

A low reflection film was formed from the cellulose acylate film of the present invention in accordance with Example 47 in Published Technical Report of the Hatsumei Kyokai (Association of Inventions) (Published Report No. 2001-1745) and was found to exhibit a good optical performance.

(5) Forming an Optical compensation Film

The cellulose acylate film of the present invention was coated with a liquid crystal layer in accordance with Example 1 in JP-A-HL11-316378, whereby a good optical compensation film was obtained.

(6) Forming a Retardation Film

The unstretched cellulose acylate films according to Examples 14 to 21 of the present invention as shown in Table 3 were each stretched in accordance with Examples 12 and 13, whereby a retardation film having a high breaking elongation and an excellent surface condition and capable of exhibiting a high level of retardation (Re and Rth) was obtained.

TABLE 3

| | Cellulose acylate | | | | | | Thermal stability | | | |
|---|---|---|---|---|---|---|---|---|---|---|
| | | B | | | | | | Reduction | | |
| | | Substi- | | | | | Reduction | in | | |
| | | tution | | | | | in | weight- | | |
| | (A) | degree of | Substi- | (A) + (B) | Number- | | number- | average | | |
| | Acetyl | groups | tuents | Total | average | | average | polymeri- | | |
| | substi- | other | other | substi- | polymeri- | | polymeriza- | zation | Plasticizer | |
| | tution | than | than | tution | zation | | tion degree | degree by | | Amount |
| | degree | acetyl | acetyl | degree | degree | Remarks | by heating | heating | Kinds* | (mass %) |
| Example 14 | 0.15 | 2.60 | Propionyl | 2.75 | 200 | | 7% | 5% | Plasticizer 3 | 8.0 |
| Example 15 | 0.20 | 2.65 | Propionyl | 2.85 | 190 | | 15% | 17% | Plasticizer 1 | 6.0 |
| Example 16 | 0.05 | 2.45 | Propionyl | 2.50 | 230 | | 12% | 15% | Plasticizer 2 | 6.0 |
| Example 17 | 0.12 | 2.60 | Propionyl | 2.72 | 160 | | 7% | 6% | none | 0.0 |
| Example 18 | 0.25 | 2.40 | Propionyl | 2.65 | 180 | | 18% | 16% | Plasticizer 4 | 10.0 |
| Example 19 | 0.40 | 2.48 | Propionyl | 2.88 | 200 | | 15% | 8% | Plasticizer 4 | 4.5 |
| Example 20 | 0.70 | 1.90 | Propionyl | 2.60 | 175 | | 14% | 17% | Plasticizer 2 | 6.0 |
| Example 21 | 1.10 | 1.85 | Propionyl | 2.95 | 160 | | 11% | 14% | Plasticizer 3 | 8.0 |
| Example 22 | 0.15 | 2.52 | Propionyl | 2.67 | 234 | CAP1 | 27% | 29% | Plasticizer 3 | 8.0 |
| | | | | | | (Synthesis | | | | |
| | | | | | | Exampel 5) | | | | |
| Example 23 | 1.00 | 1.69 | Butyryl | 2.69 | 250 | CAB3 | 13% | 10% | Plasticizer 3 | 8.0 |
| | | | | | | (Synthesis | | | | |
| | | | | | | Exampel 3) | | | | |
| Example 24 | 1.01 | 1.68 | Butyryl | 2.69 | 132 | CAB4 | 17% | 13% | Plasticizer 3 | 8.0 |
| | | | | | | (Synthesis | | | | |
| | | | | | | Exampel 4) | | | | |
| Comparative | 0.16 | 2.50 | Propionyl | 2.66 | 220 | CAP482-20 | 45% | 50% | Plasticizer 3 | 8.0 |
| Example 1 | | | | | | | | | | |

| | | | | | | | | | | Streak on | |
|---|---|---|---|---|---|---|---|---|---|---|---|
| | | | | | | | | | | liquid | |
| | | | | | | | | | Layer | crystal | |
| | Unstretched film | | | | | | Stretched film | | structure of | display | |
| | Thickness | Re | Rth | | Die | Breaking | Re | Rth | polarizing | device | |
| | (μm) | (nm) | (nm) | Yellowing | line | Elongation | (nm) | (nm) | plat | (number) | Remarks |
| Example 14 | 150 | 4 | 19 | no | no | 300% | 81 | 202 | Polarizing | 0 | Invention |
| | | | | | | | | | plate A | | |
| Example 15 | 81 | 1 | 7 | no | no | 289% | 75 | 195 | Polarizing | 0 | Invention |
| | | | | | | | | | plate A | | |
| Example 16 | 90 | 2 | 12 | no | no | 280% | 73 | 194 | Polarizing | 0 | Invention |
| | | | | | | | | | plate A | | |
| Example 17 | 85 | 2 | 13 | no | no | 285% | 68 | 190 | Polarizing | 0 | Invention |
| | | | | | | | | | plate A | | |
| Example 18 | 95 | 0 | 9 | no | no | 275% | 67 | 192 | Polarizing | 0 | Invention |
| | | | | | | | | | plate B | | |
| Example 19 | 80 | 1 | 11 | no | no | 250% | 63 | 190 | Polarizing | 0 | Invention |
| | | | | | | | | | plate B | | |
| Example 20 | 75 | 0 | 6 | no | no | 235% | 60 | 188 | Polarizing | 0 | Invention |
| | | | | | | | | | plate A | | |
| Example 21 | 90 | 1 | 8 | no | no | 200% | 58 | 185 | Polarizing | 1 | Invention |
| | | | | | | | | | plate A | | |
| Example 22 | 150 | 3 | 15 | no | no | 170% | 45 | 132 | Polarizing | 0 | Invention |
| | | | | | | | | | plate A | | |
| Example 23 | 150 | 7 | 26 | no | no | 240% | 69 | 210 | Polarizing | 0 | Invention |
| | | | | | | | | | plate A | | |
| Example 24 | 150 | 10 | 45 | no | no | 190% | 80 | 235 | Polarizing | 0 | Invention |
| | | | | | | | | | plate A | | |
| Comparative | 150 | 16 | 70 | yes | yes | 150% | 36 | 120 | Polarizing | 15 | Comp. Ex. |
| Example 1 | | | | | | | | | plate A | | |

*Elasticized 1: biphenyldiphenyl phosphate
*Elasticized 2: dioctyl adipate
*Elasticized 3: glycerol diacetate monooleate
*Elasticized 4: polyethylene glycol (MW 600)

The optical cellulose acylate film according to the present invention can be employed to make a polarizing plate or a liquid crystal dislay device, particularly of the VA type, producing a good display of pictures. The method of the present invention facilitates the manufacture of such an excellent optical film. Therefore, the present invention has a high level of industrial utility.

The present disclosure relates to the subject matter contained in Japanese Patent Application No. 25228/2005 filed on Feb. 1, 2005 and Japanese Patent Application No. 140113/2005 filed on May 12, 2005, which are expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical cellulose acylate film satisfying the requirements of (1) to (3) below, and showing a reduction of only 30% or less in both of its number-average and weight-average molecular weights when heated for 20 minutes at a temperature 10° C. higher than its melting point in an inert gas atmosphere:
(1): 2.4≦A+B<3.0
(2): 0≦A≦1.5
(3): 0.9<B<3
wherein A represents the substitution degree of acetyl groups in cellulose acylate, and B represents the total substitution degree of acyl groups having 3 to 7 carbon atoms in cellulose acylate.

2. The optical cellulose acylate film according to claim 1, satisfying the requirements of (4) to (6) below:
(4): Re≦Rth
(5): 0 nm≦Re≦300 nm
(6): 0 nm≦Rth≦500 nm
wherein Re represents an in-plane retardation of the film and Rth represents retardation of a thickness direction of the film.

3. The optical cellulose acylate film according to claim 1, satisfying the requirements of (7) to (9) below:
(7): Re≦Rth
(8); 50 nm≦Re≦100 nm
(9): 150 nm≦Rth≦250 nm
wherein Re represents an in-plane retardation of the film and Rth represents retardation of a thickness direction of the film.

4. The optical cellulose acylate film according to claim 1, having an breaking elongation of 150 to 300% when stretched at a temperature 10° C. higher than its glass transition point.

5. The optical cellulose acylate film according to claim 1, wherein the amount of residual solvent in the film is 0.01% by mass or less.

6. The optical cellulose acylate film according to claim 1, wherein the cellulose acylate is cellulose acetate propionate.

7. The optical cellulose acylate film according to claim 1, wherein the cellulose acylate is cellulose acetate butyrate.

8. The optical cellulose acylate film according to claim 1, having a thickness of 30 to 400 μm.

9. A method of manufacturing an optical cellulose acylate film according to claim 1, comprising forming a film by a melt casting process from a composition comprising cellulose acylate satisfying the requirements of (1) to (3) below:
(1): 2.4≦A+B<3.0
(2): 0≦A≦1.5
(3): 0.9<B<3
wherein A represents the substitution degree of acetyl groups in cellulose acylate, and B represents the total substitution degree of acyl groups having 3 to 7 carbon atoms in cellulose acylate.

10. The method according to claim 9, wherein the melt casting process is carried out in an inert gas atmosphere.

11. The method according to claim 9, wherein the cellulose acylate has a melting point of 170 to 230° C.

12. A polarizing plate comprising at least one cellulose acylate film according to claim 1.

13. A retardation film comprising at least one cellulose acylate film according to claim 1.

14. An optical compensation film comprising at least one cellulose acylate film according to claim 1.

15. A reflection-preventing film comprising at least one cellulose acylate film according to claim 1.

16. An image display device comprising a cellulose acylate film according to claim 1.

17. The image display device according to claim 16, comprising a polarizing plate having the cellulose acylate film.

18. The image display device according to claim 16, comprising a retardation film having the cellulose acylate film.

19. The image display device according to claim 16, comprising an optical compensation film having the cellulose acylate film.

20. The image display device according to claim 16, comprising a reflection-preventing film having the cellulose acylate film.
